(19) United States
(12) Patent Application Publication
(10) Pub. No.: US 2016/0263530 A1
(43) Pub. Date: Sep. 15, 2016

(54) FABRICATION AND MODIFICATION OF POLYMER MEMBRANES USING INK-JET PRINTING

(71) Applicant: B.G. Negev Technologies and Applications Ltd, Beer Sheva (IL)

(72) Inventors: Christopher J. Arnusch, Midreshet Ben Gurion (IL); Shai Badalov, Be'er Sheva (IL); Ekaterina Matzkin, Dimona (IL); Nathaniel Charles Wardrip, Midreshet Ben-Gurion (IL)

(73) Assignee: B.G. Negev Technologies and Applications Ltd, Beer Sheva (IL)

(21) Appl. No.: 15/162,795

(22) Filed: May 24, 2016

Related U.S. Application Data
(63) Continuation-in-part of application No. PCT/IL2014/051029, filed on Nov. 24, 2014.

(30) Foreign Application Priority Data
Nov. 28, 2013 (US) 61910051
Jun. 2, 2014 (US) 62006314
Jul. 17, 2014 (US) 62025622

(51) Int. Cl. B01D 67/00; B01D 71/56; B01D 61/02; B01D 61/14; B41J 2/01; B01D 69/10

(52) U.S. Cl. CPC B01D 67/0006; B41J 2/01; B01D 69/10; B01D 61/025; B01D 61/027; B01D 61/145; B01D 71/56; B01D 69/105; B01D 2323/345; B01D 2323/30; B01D 2323/26

(57) ABSTRACT

The present invention relates to methods for fabrication or modification of polymer membranes for water treatment utilizing ink-jet printing. The methods of the invention provide substantial advantages over the current state of the art including, inter alia, accurately delivering precise amounts of liquids to surfaces; quickly changing coating parameters; quickly controlling and changing coating compositions; and tailor-making membranes according to customer needs. The membranes fabricated or modified according to these methods have improved antifouling properties.

### CROSS-REFERENCE TO RELATED APPLICATIONS

The present application is a continuation-in-part application of International Application No. PCT/IL/2014/051029, filed Nov. 27, 2014, in which the US is designated, and claims the benefit of U.S. Provisional Patent Application No. 61/910,051, filed on Nov. 28, 2013; U.S. Provisional Patent Application No. 62/006,314, filed on Jun. 2, 2014; and U.S. Provisional Patent Application No. 62/025,622, filed on Jul. 17, 2014, the entire contents of each and all these applications being hereby incorporated by reference herein in their entirety as if fully disclosed herein.

### TECHNICAL FIELD

The present invention generally relates to methods for fabrication or modification of different types of polymer membranes for water treatment by using ink-jet printing.

Abbreviations: CNTs, carbon nanotubes; DLP, digital light processing; DMAB, N-(3-sulfopropyl)-N-methacryloyloxyethyl-N,N-dimethylammonium betaine; FPA, fluorinated diamine; FTIR, fourier transform infrared spectroscopy; LMH, flux unit (L/m²/hr); MA, methacryllic acid; MPD, m-phenylenediamine; MWCO, molecular weight cut off; PAN, polyacrylonitrile; PEG, polyethylene glycol; PEGMA, polyethylene glycol methacrylate; PES, polyethersulfone; PSf, polysulfone; SEM, scanning electron microscope; TFC, thin film composite; TMC, trimesoyl chloride; XPS, X-ray photoelectron spectroscopic.

### BACKGROUND

Dense homogeneous polymer films can separate various gaseous or liquid mixtures very effectively; however, normal thicknesses (20-200 μm) lead to very low permeation rates. Such membranes cannot be made thin enough (of the order of 0.1-1 μm) to improve permeation because they are very difficult to handle (no mechanical strength), and since such thin layers need to be supported. The development of asymmetric integrally skinned membranes by the Loeb Sourirajan method could be used to improve flux, but selectivity and rejections are reduced. A major breakthrough in the history of membrane technology was the development of composite membranes with an asymmetric structure, where a thin, dense top-layer of one material is supported by a porous sub-layer of another material, and the two layers originate from different polymeric materials. The advantage of composite membranes is that each layer can be optimized independently to obtain optimal membrane performance with respect to selectivity, permeation rate, and chemical and thermal stability.

TFC membranes are currently manufactured using interfacial polymerization, which is a technique used to apply an ultra-thin top-layer upon a porous support, wherein a polymerization reaction occurs between two very reactive monomers at the interface of two immiscible solvents. Polymers currently used as porous supports include PSf, PES and PAN. The support layer, which is generally an ultrafiltration or microfiltration membrane, is immersed in an aqueous solution containing a reactive monomer, frequently an aliphatic or aromatic amine-type; the wet amine containing film is then immersed in a second bath containing a water-immiscible solvent in which another reactive, often an aliphatic or aromatic acid chloride, has been dissolved; and the two reactive monomers react at the interface with each other to form a dense polymeric top-layer. Heat treatments are often applied to complete the interfacial reaction and to crosslink the water-soluble monomer. This process is currently optimized for roll-to-roll fabrication facilities. The advantage of interfacial polymerization is that the reaction is self-controlled through passage of a limited supply of reactants through the already formed layer, resulting in an extremely thin film of thickness within the 50 nm range. The nature of the solvents and monomers, as well as the monomer concentrations, reaction time and heat curing, define the porosity, pore size and thickness of the selective layer.

Graft polymerization is an effective way to functionalize the surface of a TFC membrane, wherein surface charge and hydrophobicity can be varied using variable amounts of positively, negatively, or neutral monomer building blocks. For example, PEG based coatings act as a hydrophilic barrier between the selective reverse osmosis surface and the bulk solution inhibiting and delaying surface attachment of bacteria. Moreover, variable amounts of differently charged monomers can increase the effectiveness of the polymer coatings and different end group functionality on modified membranes can effectively reduce the amount of fouling and ease of cleaning. Roughness can be controlled by parameters in the polymerization reaction itself, e.g., solvent mixture composition, initial monomer concentration, reaction temperature, and reaction time or types of reaction initiation employed. Redox-initiated, ionizing radiation, oxidation by ozone, low-temperature plasma and UV radiation have been the initiation methods employed, although all involve membrane modification from a bulk solution of monomers.

Water desalination is currently a relatively expensive process that is done in most cases by reverse osmosis technology and to a lesser extent utilizing NF. The leading reverse osmosis technology uses polymeric TFC membranes typically including a selective thin polyamide layer that is permeable to water but impermeable to larger molecules or salt ions, on an ultrafiltration support. Such TFC membranes have a limited life span due to degradation by oxidants (hypochlorite), mineral scaling and (bio)fouling; however, new membrane compositions or modifications to the thin polyamide top layer may lead to more durable stable membranes, membranes with unique separation characteristics, or membranes having enhanced performance characteristics such as improved water flux.

### SUMMARY

Ink-jet printing has been developed to accurately deliver pico-liter quantities of ink or other substances onto numerous types of surfaces, and is currently utilized in many applications, e.g., electronics, ceramics, protein and nucleic acid arrays, and polymers.

It has now been found, in accordance with the present invention, that using ink-jet printing for fabrication or modification of membranes for water treatment provides substantial advantages over the current state of the art. Those advantages include the ability to accurately deliver precise amounts of liquids to surfaces, which results in consistent and reproducible coatings; quickly changing coating parameters; quickly controlling and changing coating compositions; and tailor-making membranes according to customer needs. Further advantages of such a process derive from the reduced amount of monomers consumed; and reduced amount of waste which results in a more environmentally friendly process and lower waste disposal costs.

In one aspect, the present invention thus provides a method for fabrication of a membrane for reverse osmosis, nanofiltration or ultrafiltration by forming either a polyamide layer or a nanoparticle layer on a surface of a support membrane, said method comprising a step selected from:
(i) ink-jet printing on said surface of said support membrane a polyfunctional amine or polyamine functionalized nanoparticles which, upon reacting on said surface with a polyfunctional acyl halide or anhydride functional group, forms said polyamide layer; or
(ii) ink-jet printing on said surface of said support membrane nanoparticles which, upon reacting on said surface with a matrix and a crosslinker, forms said nanoparticle layer.

In one particular such aspect, the present invention provides a method as defined above, for fabrication of a TFC polyamide membrane, said method comprising:
(i) ink-jet printing of an aqueous solution of a polyfunctional amine or polyamine functionalized nanoparticles on a surface of a support membrane; and
(ii) treating the printed surface of said support membrane with a water-immiscible organic solution of a polyfunctional acyl halide or anhydride functional group thereby interfacially polymerizing said polyfunctional amine or polyamine functionalized nanoparticles with said polyfunctional acyl halide or anhydride functional group on said surface of said support membrane, thus forming a polyamide layer on said surface of said support membrane.

In another particular such aspect, the present invention provides a method as defined above, for fabrication of a membrane coated with nanoparticles, said method comprising ink-jet printing of a solution of said nanoparticles on a surface of a support membrane to thereby form, upon reaction of said nanoparticles with a matrix and a crosslinker, a nanoparticle layer on said surface of said support membrane, wherein (i) a matrix solution comprising said matrix and a crosslinking solution comprising said crosslinker are ink-jet printed on said surface of said support membrane simultaneously with said nanoparticle solution; or (ii) said surface of said support membrane is pretreated with said matrix solution, and said crosslinking solution is ink-jet printed on said surface of said support membrane simultaneously with said nanoparticle solution; or (iii) said surface of said support membrane is pretreated with said matrix solution and said crosslinking solution; or (iv) said matrix solution is ink-jet printed on said surface of said support membrane, optionally simultaneously with said nanoparticle solution, and said surface of said support membrane is then submersed in said crosslinker solution.

In another aspect, the present invention provides a membrane fabricated according to any one of the fabrication methods defined above.

In a further aspect, the present invention provides a method for modification of a membrane, said method comprising:
(i) activating a surface of said membrane, preferably with plasma, atmospheric plasma, one or more chemical radical initiators, or a UV activated initiator; and
(ii) treating the activated surface of said membrane with an aqueous solution containing monomers capable of polymerizing with each other and onto the surface of said membrane, thus forming a modified TFC membrane having improved antifouling properties while maintaining or improving salt rejection.

In yet another aspect, the present invention provides a modified membrane obtained according to the modification method defined above.

### BRIEF DESCRIPTION OF THE DRAWINGS

FIGS. 1A-1D show SEM top surface images (×80,000) of a control PAN-HV3 ultrafiltration support membrane (1A); a conventional way made polyamide TFC membrane (1B); a 2-times MPD printed membrane (1C); and a 4-times MPD printed membrane (1D), as well as FTIR spectra of control PAN-HV3 ultrafiltration support membrane (CON) and 2-times MPD printed membrane (2MPD) (1E); and of control PAN-HV3 ultrafiltration support membrane (CON) and 4-times MPD printed membrane (4MPD) (1F).

FIGS. 2A-2B show SEM top surface images (2A, ×100,000) of PES support membrane (control-no printing, panel A); PSf support membranes fabricated by interfacial polymerization of two reactive monomers (panels B-E show 1, 2, 4 and 5 prints, respectively); and PES support membrane fabricated by the conventional method using the same monomers (panel F); and the FTIR spectra of the membrane surfaces shown in 2A, panels B-E (2B).

FIGS. 3A-3E show different patterns of printed polyamide (3A); SEM images (×50,000) of printed TFC membranes (3B), where “monomer 1” images are areas where only MPD were applied and “printed monomer 2” images are areas where congo red/MPD mixtures were printed; an image of a dry membrane (3C); an image of a membrane after immersion in aqueous acid solution (HCl) (3D); and an image of a membrane after subsequent immersion in aqueous base solution (NaOH) (3E) (actual size of each one of the colored squares in 3C-3E is 3×3 mm).

FIGS. 4A-4D show a schematic representation of interfacial polymerization using ink-jet printing by first soaking the support in one monomer, and printing a second monomer on top before adding TMC (4A); the contact angle measurements on polyamide patterned membrane surface, wherein the “white” area represents polyamide made of MPD+TMC (4B), and the “black” area represents polyamide made of MPD+printed fluorinated diamine+TMC (4C); an XPS analysis of MPD/fluorinated diamine-polyamide printed membranes (PA—control membrane; FPA—membrane printed with fluorinated diamine) (4D); a graph showing flux measurements of different types of membranes as indicated (4E); and a graph showing NaCl rejection with ink-jet printed membranes compared to conventionally made membranes (4F).

FIGS. 5A-5B show graphs demonstrating the salt rejection (5A) and water permeability (5B) of control polyamide membrane (CPA) and printed polyamide membranes made by variable number of full surface cover prints of amine-functionalized nanodiamonds. Test conditions: feed: [NaCl]=1500 ppm aqueous solution, transmembrane pressure (TMP)=20 bar, T=25° C.

FIG. 6 schematically illustrates a membrane modification process, wherein the membrane surface is first activated by either atmospheric plasma or chemical initiators, and graft polymerization process is then carried out by either dip-coating method (a) or ink jet printing (b).

FIG. 7 shows a FTIR characterization of ESPA-1 reverse osmosis membranes treated with atmospheric plasma activation and ink-jet printed with MA and PEGMA aqueous solution. The number of prints varied from 1 to 5.

FIG. 8 shows the peak ratio (1719 cm⁻¹/1488 cm⁻¹) and contact angle of ESPA-1 membranes treated with atmospheric plasma after the monomer solution (MA:PEGMA) has been deposited thereon by ink-jet printing a different number of times (1, 3 and 5).

FIG. 9 shows the permeability and rejection of ESPA-1 membranes treated with atmospheric plasma after the monomer solution (MA:PEGMA) has been deposited thereon by ink-jet printing a different number of times (1, 3 and 5).

FIG. 10 illustrations a fully filled black square, i.e., a fully covered membrane (left panel, no pattern), black squares 0.2×0.2 cm covering 50% of the total space (a checkerboard pattern, “pattern 1”) (middle panel), and a zig-zag covering 85% of the space (striped pattern, “pattern 2”) (right panel).

FIG. 11 shows the peak ratio (1719 cm⁻¹/1488 cm⁻¹) and contact angle of ESPA-1 membranes treated with atmospheric plasma after monomer aqueous solution MA/PEGMA has been deposited thereon by ink-jet printing with an Epson L110 printer using different types of patterns: checkerboard covering 50% of the total space (“pattern 1”); zig-zag covering 85% of the total space (“pattern 2”); full cover (no pattern); and control (unmodified membrane).

FIGS. 12A-12B show the permeability and rejection of ESPA-1 membranes treated with atmospheric plasma after monomer aqueous solution MA/PEGMA has been deposited thereon by ink-jet printing with an Epson L110 printer using different types of patterns: checkerboard covering 50% of the total space (“pattern 1”); zig-zag covering 85% of the total space (“pattern 2”); full cover (no pattern); and control (unmodified membrane) (12A); and AFM images showing the roughness of the above membranes (area measured, 50 μm×50 μm) (12B).

FIG. 13 shows the peak ratio (1719 cm⁻¹/1488 cm⁻¹) and contact angle f ESPA-1 membranes treated with redox initiators (K₂S₂O₈, and K₂S₂O₅) by soaking for different times (between 10 to 90 min), and after the monomer solution (MA:PEGMA) has been deposited thereon by ink-jet printing as a full coverage (100%).

FIG. 14 shows the peak ratio (1719 cm⁻¹/1488 cm⁻¹) and contact angle of ESPA-1 membranes treated with redox initiators (K₂S₂O₈, and K₂S₂O₅) by soaking for different times (between 10 to 30 min), after MA:PEGMA aqueous solution has been deposited thereon by ink-jet printing using different types of patterns: checkerboard covering 50% of the total space (pattern 1); zig-zag covering 85% of the total space (pattern 2); and control (unmodified membrane).

FIG. 15 shows the permeability and rejection of ESPA-1 membranes treated with redox initiators (K₂S₂O₈, and K₂S₂O₅) by soaking at different times (between 10 to 90 min) after the monomer solution (MA:PEGMA) has been deposited thereon by ink-jet printing as a full (100%) coverage (no pattern).

FIG. 16 shows the permeability and rejection of ESPA-1 membranes treated with redox initiators (K₂S₂O₈, and K₂S₂O₅) by soaking at different times (between 10 to 30 min) after MA:PEGMA aqueous solution has been deposited thereon by ink-jet printing by using different types of patterns: checkerboard covering 50% of the total space (pattern 1); zig-zag covering 85% of the total space (pattern 2); and control (unmodified membrane).

FIG. 17 shows a graph demonstrating sheet resistance of modified reverse osmosis membranes vs. amount of printed CNTs.

FIGS. 18A-18D show visualization of the patterned modifications via FTIR analysis and staining with toluidine blue. (18A) FTIR absorbance/1586 cm⁻¹ of membranes under different reaction conditions as indicated: UV radiation 405 nm (30 min), photoinitiator (PI, 1% w/w methanol), acrylate monomers PEGMA/MA (M). (18B) FTIR absorbance ratio 1715/1586 cm⁻¹ at different reaction time points (photoinitiator (1% w/w methanol), acrylate monomers PEGMA/MA. (18C) FTIR absorbance ratio 1715/1586 cm⁻¹ across a modified membrane. (18D) Images of modified membranes using various patterns.

FIG. 19 shows FTIR absorbance ratio (1715/1586 cm⁻¹) vs. photoinitiator concentration: Each membrane was irradiated for one minute. Error bars denote standard deviations for 4 replicate membranes.

FIG. 20 shows SEM membrane images: unmodified control membrane (UH050) (left panel); a membrane after being coated with an irgacure 819 solution (1% w/w methanol) (right panel).

FIGS. 21A-21B show membrane flux using secondary treated wastewater. (21A) Membranes were fouled for 24 hours: Perpendicular pattern (PE, dotted lines, ZW (), PEGMA (▪), PEGMA/MA (▴); parallel pattern (PA, normal lines, ZW (∘), PEGMA (□), PEGMA/MA (Δ); control (×). (21B) Normalized flux at 24 hours. ZW—zwitterionic. The average values of four replicate experiments (N=4) are reported.

FIG. 22 shows summary of genus Sphingomonas observed at three time points, across all samples summarized by membrane pattern (top axis) and surface chemistry (right axis). Control (C), full (F), parallel (PA), perpendicular (PE), zwitterionic (ZW).

FIGS. 23A-23B show summary of alpha diversity matrices (Shannon and Simpson) summarized by membrane pattern (23A) and surface chemistry (23B). Control (C), full (F), parallel (PA), perpendicular (PE), zwitterionic (ZW).

FIG. 24 shows summary of alpha diversity matrices (Shannon and Simpson) as a progression of time.

FIG. 25 shows a schematic representation of a process for fabrication of a TFC membrane including novel printer modules.

### DETAILED DESCRIPTION OF THE PREFERRED EMBODIMENTS

The present invention provides various methods for fabrication or modification of membrane surfaces precisely in the micro-domain, utilizing ink-jet printing to give a greater control over the placement of nano- and micro-heterogeneity of the membrane composition, and resulting in improved properties. Any ink-jet system that can deliver solvents to substrates may be employed in the methods of the invention. These solvents may be either aqueous or organic, and may contain, e.g., dissolved compounds, monomers, polymers, or nanoparticles. Membranes fabricated or modified in this way may consist of multiple compositions in micro domains that show novel separation properties, novel functionality, and enhanced membrane performance over the state of art.

According to the present invention, multiple materials are grafted to the surface in patterns. While the main limitation of the current membranes consisting of a grafted layer on top of the separation layer is a less controllable reaction, the present invention overcomes this limitation by depositing precise amounts of reactants to the surface, which results in differing amounts of modification, where surface properties can be set and controlled.

Because of the nature of the ink-jet printer, incompatible materials may be loaded in separate cartridges or reservoirs and printed on the substrate when this is not possible with other coating methods for example dip coating. “Mosaic” membranes are an example of this possibility.

In one aspect, the present invention provides a method for fabrication of a membrane for reverse osmosis, nanofiltration or ultrafiltration by forming either a polyamide layer or a nanoparticle layer on a surface of a support membrane, said method comprising a step selected from: (i) ink-jet printing on said surface of said support membrane a polyfunctional amine or polyamine functionalized nanoparticles which, upon reacting on said surface with a polyfunctional acyl halide or anhydride functional group, forms said polyamide layer; or (ii) ink-jet printing on said surface of said support membrane nanoparticles which, upon reacting on said surface with a matrix and a crosslinker, forms said nanoparticle layer.

In certain embodiments, the support membrane used according to this method is a polymer membrane composed of, e.g., PSf, PES, PAN, polyester, polyphenyleneoxide, polyphenylenesulfide, polyvinyl chloride, polyvinylidine fluoride, polytetrafluoroethylene, polycarbonate, polyetherketone, or polyetheretherketone, or a TFC membrane including reverse osmosis and nanofiltration membranes having a polyamide surface.

In certain embodiments, the membrane fabricated by this method, as defined above, has salt rejection of 40% or more, i.e., 40%-50%, 50%-60%, 60%-70%, 70%-80%, 80%-90%, 90%-95%, 95%-99.5%, or more, and flux of 0.3-40 L/h m² bar.

In one particular such aspect, the present invention provides a method as defined above, for fabrication of a TFC polyamide membrane (hereinafter “Fabrication Method A”), said method comprising: (i) ink-jet printing of an aqueous solution of a polyfunctional amine or polyamine functionalized nanoparticles on a surface of a support membrane; and (ii) treating the printed surface of said support membrane with a water-immiscible organic solution of a polyfunctional acyl halide or anhydride functional group thereby interfacially polymerizing said polyfunctional amine or polyamine functionalized nanoparticles with said polyfunctional acyl halide or anhydride functional group on said surface of said support membrane, thus forming a polyamide layer on said surface of said support membrane.

In certain embodiments, step (i) of the Fabrication Method A is repeated n times prior to step (ii), wherein n is an integer of 1 to 5.

In certain embodiments, the ink-jet printing in step (i) of the Fabrication Method A is carried out from one or more reservoirs. In particular such embodiments, the ink-jet printing is carried out from more than one reservoir, e.g., two, three, four or more reservoirs, wherein each one of said reservoirs contains an aqueous solution of identical or different polyfunctional amine or polyamine functionalized nanoparticles.

In certain embodiments, the ink-jet printing in step (i) of the Fabrication Method A is carried out according to a predetermined pattern.

In certain embodiments, the treating in step (ii) of the Fabrication Method A is conducted by immersing the printed surface of said support membrane in said organic solution; or by ink-jet printing of the organic solution on the printed surface of said support membrane. In certain particular such embodiments, the ink-jet printing of the organic solution on the printed surface of the support membrane is carried out from either one reservoir or more than one, e.g., two, three, four or more, reservoirs, wherein each one of the reservoirs contains an organic solution of identical or different polyfunctional acyl halide or anhydride functional group. In other particular such embodiments, the ink-jet printing of the organic solution on the printed surface of said support membrane is carried out according to a predetermined pattern. In more particular such embodiments, the treating in step (ii) of this method is conducted by ink-jet printing of the organic solution on the printed surface of the support membrane, and simultaneously with the ink-jet printing of step (i).

In certain embodiments, heat treatment is applied in step (ii) of the Fabrication Method A to complete the interfacial polymerization.

In certain embodiments, the support membrane used according to the Fabrication Method A is composed of PSf, PES, PAN, polyester, polyphenyleneoxide, polyphenylenesulfide, polyvinyl chloride, polyvinylidine fluoride, polytetrafluoroethylene, polycarbonate, polyetherketone, or polyetheretherketone.

According to certain embodiments of the Fabrication Method A, the support membrane is first printed with an aqueous solution of a polyfunctional amine or polyamine functionalized nanoparticles, and the printed support membrane is then treated with a water-immiscible organic solution of a polyfunctional acyl halide or anhydride functional group.

Examples of polyfunctional amines include, without being limited to, MPD, p-phenylenediamine, 2,4-diaminotoluene, 2,5-diaminotoluene, N,N′-diphenylethylene diamine, 4-methoxy-m-phenylenediamine, 1,3,4-triaminobenzene, 1,3,5-triaminobenzene, 3,5-diaminobenzoic acid, 2,4-diaminoanisole, xylylenediamine, ethylenediamine, propylenediamine, tris(2-diaminoethyl)amine, piperazine, a fluorinated aromatic polyamine such as 5-fluoro-m-phenylenediamine and 2,5-difluoro-m-phenylenediamine, a fluorinated non-aromatic polyamine, a fluorinated alkane substituted with one or more aromatic groups, e.g., phenyl groups, each containing at least one amino group such as 2,2-bis(3-amino-4-hydroxyphenyl)hexafluoropropane, a fluorinated alkane diol interrupted by one or more aromatic groups each containing at least one amino group such as 2,2′-(methylenebis(3-amino-6,1-phenylene))bis(1,1,1,3,3,3-hexafluoropropan-2-ol), a chiral polyamine, and mixtures thereof.

Examples of polyamine functionalized nanoparticles include, without limiting, CNTs, metallic nanoparticles such as silver, copper and titanium (including titanium oxide) containing nanoparticles, nanodiamonds, or graphene quantum dots, which are polyamine functionalized.

Non-limiting examples of polyfunctional acyl halides include TMC, trimellitic acid chloride, terephthaloyl chloride, isophthalolyl chloride, cyclohexane-1,3,5-tricarbonyl chloride, 1,3,5,7-tetracarbonyl chloride, adamantane-2,6-dione, 1-isocyanato-3,5-benzenedicarbonyl chloride(5-isocyanato-isophthaloyl chloride), aromatic polyfunctional acyl halides such as trimesic acid chloride, terephthalic acid chloride, isophthalic acid chloride, biphenyl dicarboxylic acid chloride and naphthalene dicarboxylic acid dichloride, alicyclic polyfunctional acyl halides such as cyclopropane tricarboxylic acid chloride, cyclobutane tetracarboxylic acid chloride, cyclopentane tricarboxylic acid chloride, cyclopentane tetracarboxylic acid chloride, tetrahydrofuran tetracarboxylic acid chloride, cyclopentane dicarboxylic acid chloride, cyclobutane dicarboxylic acid chloride, cyclohexane dicarboxylic acid chloride and tetrahydrofuran dicarboxylic acid chloride, and mixtures thereof.

Examples of anhydride functional groups include, without being limited to, polyfunctional acid anhydrides such as mellitic anhydride, or polyfunctional acid anhydride halides such as 4-chloroformyl phthalic anhydride.

According to the Fabrication Method A, the water-immiscible organic solution of the polyfunctional acyl halide or anhydride functional group may be based on any suitable organic solvent in which the polyfunctional acyl halide or anhydride functional group is dissolved. Particular such solvents comprise, without being limited to, a hydrocarbon selected from a straight or iso-(C₅-C₁₂)alkane such as pentane, isopentane, hexane, isohexane, heptane, isoheptane, octane, isooctane, nonane, isononane, decane, isodecane, undecane isoundecane, dodecane, and isododecane, a (C₅-C₁₂)cycloalkane such as cyclopentane, cyclohexane, cycloheptane, cyclooctane, cyclononane, cyclodecane, cycloundecane and cyclododecane, or a mixture thereof. Such hydrocarbons may optionally be halogenated, i.e., substituted with one, two, three, four or more, halogen atoms, i.e., fluorine, chlorine, bromine, or iodine but preferably fluorine. The hydrocarbons may be substituted at any position. In a particular embodiment, the organic solvent in which the polyfunctional acyl halide or anhydride functional group is dissolved comprises a mixture of alkanes and/or isoalkanes, e.g., a commercially available mixture of (C₁₀-C₁₂)isoalkanes such as Isopar™ G Fluid.

According to the Fabrication Method A, upon treatment of the printed support membrane with a water-immiscible organic solution of said polyfunctional acyl halide or anhydride functional group, and consequently interfacial polymerization of the polyfunctional amine or polyamine functionalized nanoparticles with the polyfunctional acyl halide or anhydride functional group, a polyamide layer is formed on top of the support membrane. In certain embodiments, the polyamide layer formed has a thickness in the range of 0.01-1, preferably 0.01-0.2, μm.

In certain embodiments, the surface of the support membrane ink-jet printed in step (i) of the Fabrication Method A, according to any one of the embodiments defined above, is soaked in an aqueous solution of a polyfunctional amine or polyamine functionalized nanoparticles, and the excess solution is then removed if necessary, e.g., by rolling the membrane with a rubber roller or using an air knife, prior to step (i) and/or after step (i). The support membrane can be soaked in said aqueous solution of polyfunctional amine or polyamine functionalized nanoparticles for any sufficient period of time, e.g., for 1-30 minutes, wherein the concentration of the polyfunctional amine or polyamine functionalized nanoparticles in said solution may be in the range of 0.1-20% (w/v %), preferably in the range of 0.5-10% (w/v %). In particular such embodiments, the polyfunctional amine or polyamine functionalized nanoparticles in the aqueous solution ink-jet printed in step (i), and the polyfunctional amine or polyamine functionalized nanoparticles in the aqueous solution in which the surface of the support membrane is soaked prior to step (i) are identical or different.

In a particular embodiment exemplified herein, the present invention relates to a method for fabrication of a TFC polyamide membrane as defined above, said method comprising (i) ink-jet printing of an aqueous solution of MPD or 2,2-bis(3-amino-4-hydroxyphenyl)hexafluoropropane on a surface of a porous support membrane n times, wherein n is an integer of 1 to 5, and said support membrane is composed of PSf, PES or PAN; and (ii) treating the printed surface of the support membrane with a solution of TMC in n-hexane thereby interfacially polymerizing said MPD with said TMC on the surface of said support membrane, thus forming a polyamide layer on top of said surface of said support membrane. In a more particular such embodiment, said support membrane is soaked in an aqueous solution of MPD and the excess solution is then removed, if necessary, prior to step (i).

In another particular such aspect, the present invention provides a method as defined above, for fabrication of a membrane coated with nanoparticles (hereinafter “Fabrication Method B”), said method comprising ink-jet printing of a solution of said nanoparticles on a surface of a support membrane to thereby form, upon reaction of said nanoparticles with a matrix and a crosslinker, a nanoparticle layer on said surface of said support membrane, wherein (i) a matrix solution comprising said matrix and a crosslinking solution comprising said crosslinker are ink-jet printed on said surface of said support membrane simultaneously with said nanoparticle solution; or (ii) said surface of said support membrane is pretreated with said matrix solution, and said crosslinking solution is ink-jet printed on said surface of said support membrane simultaneously with said nanoparticle solution; or (iii) said surface of said support membrane is pretreated with said matrix solution and said crosslinking solution; or (iv) said matrix solution is ink-jet printed on said surface of said support membrane, optionally simultaneously with said nanoparticle solution, and said surface of said support membrane is then submersed in said crosslinker solution.

In certain embodiments, the ink-jet printing of the nanoparticle solution according to the Fabrication Method B is repeated n times, wherein n is an integer of 1 to 300.

In certain embodiments, the ink-jet printing of the nanoparticle solution according to the Fabrication Method B is carried out from one or more reservoirs. In particular such embodiments, the ink-jet printing is carried out from more than one reservoir, e.g., two, three, four or more reservoirs, wherein each one of said reservoirs contains a solution of identical or different nanoparticles.

In certain embodiments, the ink-jet printing of the nanoparticle solution according to the Fabrication Method B is carried out according to a predetermined pattern.

In all cases wherein the Fabrication Method B comprises ink-jet printing of the matrix solution on said support membrane, i.e., when carried out according to options (i) or (iv) described hereinabove, the nanoparticle solution and the matrix solution can be ink-jet printed from two different reservoirs or, alternatively, together from one or more reservoirs.

In certain embodiments, the Fabrication Method B further comprises heat treatment aimed at allowing the crosslinker to completely react with the matrix and the nanoparticles. Such treatment may be carried out, e.g., in a temperature ranging from room temperature to about 100° C.

In certain embodiments, the support membrane utilized according to the Fabrication Method B is composed of PSf, PES, PAN, polyester, polyphenyleneoxide, polyphenylenesulfide, polyvinyl chloride, polyvinylidine fluoride, polytetrafluoroethylene, polycarbonate, polyetherketone, polyetheretherketone, or a TFC membrane including reverse osmosis and nanofiltration membranes having a polyamide surface.

The crosslinker utilized according to the Fabrication Method B is a compound capable of cross-linking with both an alcohol and a carboxylic or amine moiety. Examples of such crosslinkers include, without limiting, dialdehydes such as glyoxal, malondialdehyde, succindialdehyde, glutaraldehyde and phthalaldehyde. The matrix utilized according to this method is a hydrophilic polymer capable of cross-linking with said crosslinker, e.g., polyvinylalcohol.

Examples of nanoparticles that may be ink-jet printed according to the Fabrication Method B include, without being limited to, CNTs, metallic nanoparticles such as silver, copper and titanium (including titanium oxide) containing nanoparticles, nanodiamonds, graphene quantum dots, or other carbon based nanoparticles. Upon crosslinking said matrix and said cross-linker, such nanoparticles will be embedded within the matrix-cross-linker layer formed on top of said support membrane. According to Fabrication Method B, the nanoparticles ink-jet printed may also be functionalized with any functional groups capable of reacting with said cross-linker and linking to said matrix, e.g., with hydroxyl and/or carboxyl groups. Particular such functionalized nanoparticles are CNTs having hydroxyl and carboxyl groups. In case functionalized nanoparticles are utilized, upon crosslinking said matrix and said cross-linker, such nanoparticles will be covalently linked into the matrix coating formed on top of said support membrane.

In another aspect, the present invention provides a membrane fabricated according to the fabrication method defined herein, more particularly a TFC polyamide membrane fabricated by the Fabrication Method A or a nanoparticles-coated membrane fabricated by the Fabrication Method B.

In certain embodiments, the membrane of the present invention is a TFC polyamide membrane having salt rejection of 40-99.5% and flux of 0.3-40 L/h m² bar; or wherein the thickness of said polyamide layer is in the range of 10-500 nm, e.g., in the range of 10-200, 10-300, 10-400 or 10-450 nm.

The membrane fabricated according to the any of the fabrication methods may be used for water treatment, e.g., for reverse osmosis, nanofiltration or ultrafiltration. It should be noted that while nanofiltration TFC membranes have salt rejection of about 50%, reverse osmosis membranes have salt rejection that is remarkably higher and may reach 80%, 90%, 95% and even 99.5%.

In a further aspect, the present invention provides a method for modification of a membrane (hereinafter “Modification Method”), said method comprising: (i) activating a surface of said membrane, preferably with plasma, atmospheric plasma, one or more chemical radical initiators, i.e., redox initiators, or a UV activated initiator, i.e., a photoinitiator; and (ii) treating the activated surface of said membrane with an aqueous solution containing monomers capable of polymerizing with each other and onto the surface of said membrane, thus forming a modified TFC membrane having improved antifouling properties while maintaining or improving salt rejection.

In certain embodiments, the surface of the membrane modified according to the Modification Method is activated with plasma or atmospheric plasma.

In certain embodiments, the surface of the membrane modified according to the Modification Method is activated with one or more chemical radical initiators, i.e., redox initiators. The term “chemical radical initiators” or “redox initiators”, as used herein interchangeably, refers to chemical agents that form free radicals capable of initiating polymerization of the monomers, e.g., azo compounds such as azobisisobutyronitrile, and organic peroxides such as di-tert-butyl peroxide, benzoyl peroxide, and methyl ethyl ketone peroxide; or to a mixture of two chemical agents that form free radicals capable of initiating polymerization of the monomers when in contact with each other, e.g., a mixture of a peroxydisulfate salt such as potassium persulfate (K₂S₂O₈) and a peroxydisulfite salt such as potassium metabisulfite (K₂S₂O₅).

In certain embodiments, the surface of the membrane modified according to the Modification Method is activated with a UV activated initiator, i.e., a photoinitiator. The term “UV activated initiator” or “photoinitiator”, as used herein interchangeably, refers to any molecule which creates reactive species, i.e., free radicals, upon exposure to UV radiation, and is thus capable of initiating polymerization of the monomers. It should thus be clear that activation of said surface with a UV activated initiator occurs only once the surface is irradiated with UV that is, in fact, following step (ii) of said method. Non-limiting examples of suitable photoinitiators include acetophenones, benzophenones, triazines, benzoins, benzoin ethers, xanthones, thioxanthones, acridines and benzoquinones. Preferred photoinitiators include Irgacure series such as Igracure 149, Igracure 184, Igracure 261, Igracure 369, Igracure 500, Igracure 651, Igracure 754, Irgacure 784, Igracure 819, Igracure 907, Igracure 1000 and Igracure 2959 (trade names, Ciba Specialty Chemicals Co.), as well as Degacure series such as Degacure K126 and Degacure K185 (trade names, Degussa GmbH). In a preferred embodiment, the photoinitiator is Irgacure 184, Irgacure 369 or Irgacure 819.

In certain embodiments, the activated surface of the membrane modified according to the Modification Method is treated in step (ii) by immersing in an aqueous solution containing said monomers capable of polymerizing with each other and onto said surface of said membrane; or by ink jet printing of an aqueous solution containing said monomers onto said surface of said membrane. In particular such embodiments, the activated surface of the membrane is treated by ink jet printing of said aqueous solution according to a predetermined pattern.

In certain embodiments, the surface of the membrane modified according to the Modification Method is activated with a photoinitiator, e.g., a photoinitiator of the Irgacure series such as Igracure 819; the activated surface of the membrane is treated with said aqueous solution containing said monomers; and the monomers are then polymerized with each other and onto the surface of said membrane upon UV irradiation of the treated surface of said membrane.

In certain embodiments, the membrane modified according to the Modification Method is a polymer membrane selected from TFC membranes including TFC polyamide membranes fabricated according to the method defined above, reverse osmosis membranes, nanofiltration membranes, ultrafiltration membranes, or microfiltration membranes.

In certain embodiments, the monomers contained in the aqueous solution ink-jet printed in step (ii) of the Modification Method are either charged or neutral organic molecules containing an acrylic moiety. Examples of such charged or neutral organic molecules include, without being limited to, MA, PEGMA, 2-[methacryloyloxyethyl]trimethylammonium chloride, 3-sulfopropyl methacrylate potassium salt, N-(3-sulfopropyl)-N-methacryloyloxyethyl-N,N-dimethylammonium betaine, and neutral acrylic-containing monomers including fluorine such as 3-pentafluoropropyl acrylate. According to the method of the present invention, these monomers may be present in the aqueous solution at any ratio.

In one particular embodiment exemplified herein, the Modification Method of the present invention comprises (i) activating a surface of said membrane with atmospheric plasma; and (ii) ink jet printing of an aqueous solution containing charged or neutral organic molecules containing an acrylic moiety, e.g., monomers of MA and PEGMA, at any ratio, optionally according to a predetermined pattern.

In another particular embodiment exemplified herein, the Modification Method of the present invention comprises (i) activating a surface of said membrane with one or more chemical radical initiators, e.g., an azo compound such as azobisisobutyronitrile, an organic peroxide such as di-tert-butyl peroxide, benzoyl peroxide, and methyl ethyl ketone peroxide, or a mixture of a peroxydisulfate and peroxydisulfite salts such as a mixture of potassium persulfate and potassium metabisulfite; and (ii) ink jet printing of an aqueous solution containing charged or neutral organic molecules containing an acrylic moiety, e.g., monomers of MA and PEGMA, at any ratio, optionally according to a predetermined pattern.

In yet another particular embodiment exemplified herein, the Modification Method of the present invention comprises (i) activating a surface of said membrane with a UV activated initiator, e.g., a photoinitiator of the Irgacure series such as Igracure 819; (ii) immersing the activated surface of said membrane in an aqueous solution containing charged or neutral organic molecules containing an acrylic moiety, e.g., monomers of MA and PEGMA, at any ratio; and UV irradiating of the treated surface of said membrane, optionally according to a predetermined pattern.

In still another particular embodiment, the Modification Method of the present invention comprises (i) activating a surface of said membrane with a UV activated initiator, e.g., a photoinitiator of the Irgacure series such as Igracure 819; (ii) ink jet printing of an aqueous solution containing charged or neutral organic molecules containing an acrylic moiety, e.g., monomers of MA and PEGMA, at any ratio, optionally according to a predetermined pattern; and UV irradiating of the treated surface of said membrane.

In yet another aspect, the present invention provides a modified membrane obtained according to the Modification Method defined above.

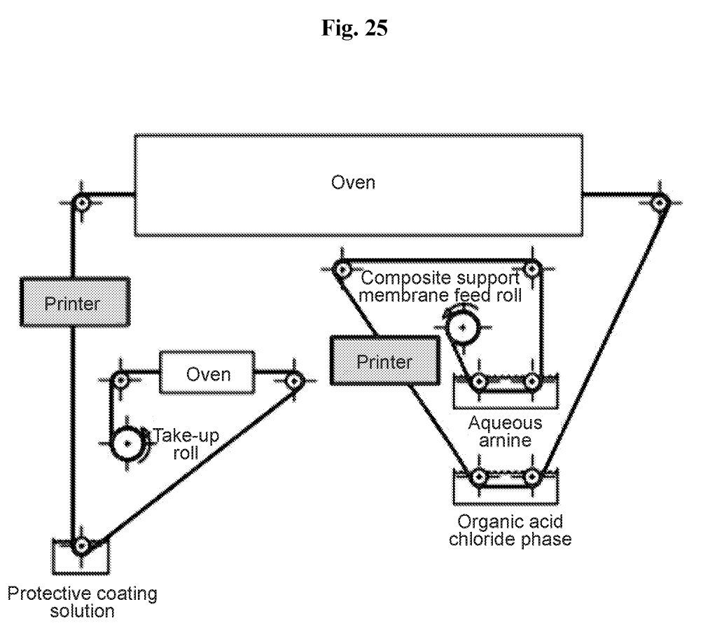

The various methods described herein are envisioned to be used as stand-alone membrane fabrication and/or modification technologies, or implemented into current membrane fabrication and modification facilities as shown schematically in FIG. 25. For instance, the device or technique of the present invention may be engineered or modified to fit into currently available fabrication infrastructures for tailored-made membranes with customer defined characteristics.

Water treatment membranes are especially susceptible to fouling as the surfaces are continuously exposed to a diverse community of microbes, dissolved and suspended organic substances, and inorganic salts carried in the water across the membrane surface. Fouling results in increased operating pressure, the loss of productivity, deterioration in permeate water quality, and gradual degradation of the membrane. Ultimately fouling increases operating costs (pumping, cleaning agents, membrane replacement) and downtime (Ke et al., 2013; Vanysacker et al., 2013). Biofouling can contribute greater than 45% of membrane fouling (Nguyen et al., 2012). The initial attachment of bacteria is a crucial step in the development of membrane biofilms and thus fouling (Haas et al., 2015).

An effective strategy to reduce fouling on membrane surfaces is to modify the surfaces or surface properties and restrict direct adhesion on the polymer membrane surface (Mauter et al., 2011; Liang et al., 2013; Ye et al., 2015; Rana and Matsuura, 2010). Graft polymerization has been shown to be an effective way to coat the surface of membranes to tailor surface properties of the polymer, including reduced absorption of proteins and other organic compounds (thong et al., 2013; Li et al., 2015; Gu et al., 2013; Lin et al., 2010; Imbrogno et al., 2015), hydrophilicity, and bacterial attachment (Eshet et al., 2011; Freger et al., 2002). Interestingly, natural systems that exhibit low fouling employ more than physical and chemical characteristics of the surface but also surface patterned topography to restrict fouling. Topographic patterns on membranes and other surfaces in the laboratory have also exhibited great promise for the modulation of fouling behavior. Both surface topography and chemistry were reported to improve antifouling marine coatings (Efimenko et al., 2009).

In a study described in Example 4 hereinafter, patterned UV light from a 3D printer with DLP technology was adapted to initiate grafting of polymers onto surfaces of membranes. This stereolithographic technique achieved a striped pattern in three different polymer compositions, and was tested in a microfluidic cross-flow cell (Haas et al., 2015; Wardrip and Arnusch, 2016) in an orientation perpendicular or parallel to the direction of the inlet water flow. The aqueous feed test solution consisted of secondary treated wastewater, representing a complex mixture of salts, natural organic matter, colloidal material and microbes. As observed, a parallel pattern orientation improved normalized flux performance up to 85% after 24 h over the control membrane, which may indicate reduced fouling. Bacterial community analysis of material collected from the membrane surface indicated that all modified membranes reduced bacterial diversity (Shannon index, modified membranes: 1.79-2.36 vs. control: 2.63) and significantly altered community composition (ANOSIM and distance-based redundancy analyses using Bray-Curtis, weighted and unweighted UniFrac, p<0.01).

The invention will now be illustrated by the following non-limiting Examples.

### EXAMPLES

### Example 1

### Membrane Fabrication Via Ink-Jet Printing

In general, an Epson L110 printer was used with the front paper feed roller removed to prevent damage to the membrane surface. The middle portion of the rear roller was removed as well. Optionally, if oxygen sensitive compounds are used, a flexible tube was attached onto the print head for application of nitrogen gas in the vicinity of the print head. The amine monomer MPD was dissolved in water at different concentrations and to this 0-100 ppm Na₂CO₃ was added to ensure that the MPD amine groups would not become protonated as HCl is generated in the polymerization process, and 0-5% (w/v) ethylene glycol. This solution was poured into the 4 color reservoirs of the Epson L110 printer instead of the CMYK inks. The aqueous MPD solution was printed onto an ultra-filtration (UF) polymer support membrane. The number of prints as well as pattern can be controlled using Photoshop software or other programs such as GNU Image Manipulation Program (GIMP). Percent or each color can be adjusted to control the amount of each substance to be printed. The trimesoyl chloride (TMC) solution (0.05-0.13% in hexane) was poured on top, or alternatively added to the color reservoirs and printed on the surface. Alternatively, the amine monomers and nanoparticles may be added to a commercially available printing ink “base” solution, consisting of 55% distilled water, 35% glycerol and 10% Kodak Photo-Flo 200 solution (containing 60-70% water, 25-30% propylene glycol, and 5-10% p-tert-octylphenoxy polyethoxyethyl alcohol).

### Interfacial Polymerization Printing on PES Ultrafiltration Supports

TFC polyamide printed membranes were made using 5% (w/v) MPD/water solution containing 100 ppm Na₂CO₃ and 5% (w/v) ethylene glycol. This solution was added to all the tanks in the printer and “100% black” was then printed 5 times on the PES ultrafiltration support. Once printed, the membranes were treated with 0.05% (w/v) TMC/n-hexane solution, similar to the conventional method. As observed, a polyamide layer was formed with increased salt rejection from 5% to 54%, with associated loss in flux. The hydrophilicity increased as seen from the contact angle decrease from 104 degrees to 80 degrees. The test results of the membranes fabricated by the above method compared to the support membrane are shown in Table 1.

TABLE 1

| | | | Contact |
|---|---|---|---|
| | Flux (LMH) | Salt rejection (%) | angle (°) |
| 5 kDa PES | 425.51 | 5 | 104 ± 3 |
| ultrafiltration support | | | |
| 5 times MPD printed | 3.94 | 54 | 80 ± 6 |
| membrane | | | |

### Interfacial Polymerization Printing on PAN Ultrafiltration Supports

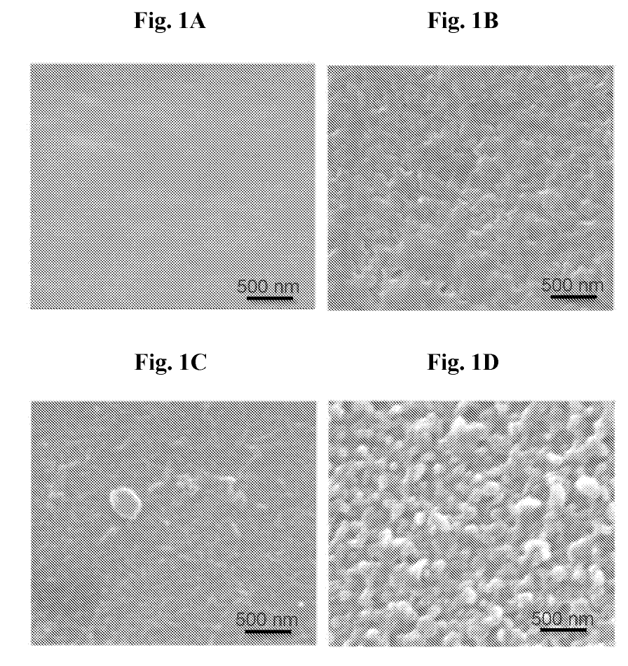

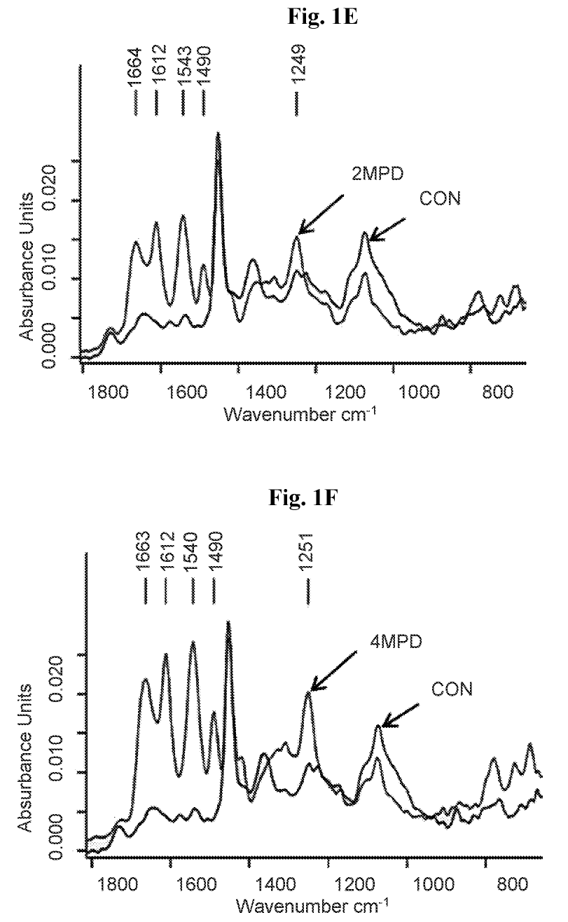

TFC polyamide printed membranes were made using 10% (w/v) MPD/water solution containing 100 ppm Na₂CO₃ and 2.5% (w/v) ethylene glycol (FIG. 1). This solution was added to all the tanks in the printer and “100% black” was then printed various number of times on the PAN ultrafiltration support. Once printed, the membranes were treated with 0.13% (w/v) TMC/n-hexane solution, similar to the conventional method. As observed, a polyamide layer was formed with increased salt rejection from 0% to 79%, with associated loss in flux (Table 2 below). These were compared to membranes made in the conventional way using these solutions. As shown in FIG. 1 and summarized in Table 2, the membranes prepared according to the method of the invention had a unique morphology which gives unique performance characteristics such as reduced fouling and higher flux. As particularly shown in FIGS. 1E and 1F, FTIR measurements showed an appearance of 4 new peaks at approximately 1664, 1612, 1543 and 1490 cm⁻¹, characterizing an aromatic polyamide polymer. Four times printing gave stronger signals than two times printing, indicating a thicker or denser layer.

TABLE 2

| | Flux (LMH) | Salt rejection (%) |
|---|---|---|
| PAN-HV3 support | 2025.07 | 0 |
| Conventional method membrane | 6.04 | 33.06 |
| 2-times MPD printed membrane | 6.66 | 48.99 |
| 4-times MPD printed membrane | 10.19 | 79.23 |

### Interfacial Polymerization Printing on PES Ultrafiltration Supports

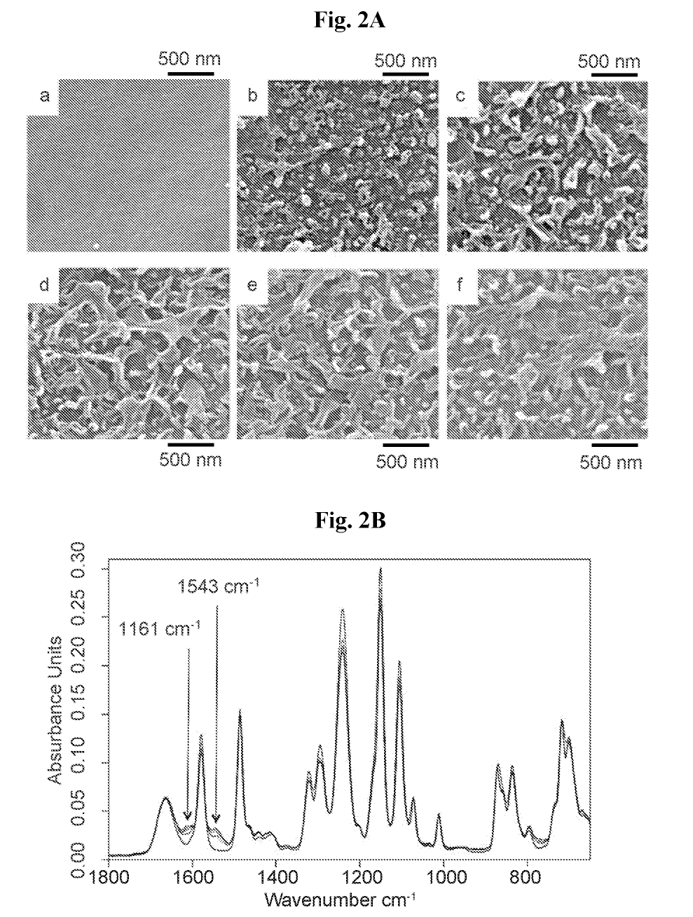

TFC polyamide printed membranes were made using 2.5% (w/v) MPD/water solution containing 100 ppm Na₂CO₃ and 5% (w/v) ethylene glycol (FIG. 2). This solution was added to all the tanks in the printer and “100% black” was then printed various number of times on the PES ultrafiltration support. Once printed, the membranes were treated with 0.13% (w/v) TMC/n-hexane solution, similar to the conventional method. As observed, a polyamide layer was formed with differing morphology based on the number of prints. These were compared to membranes made in the conventional way using these solutions. Morphology of 4 and 5 prints was similar to that of a membrane made in the conventional way. FTIR spectra showed also an appearance of peaks at approximately 1611 and 1543 cm⁻¹, which are characteristic of an aromatic polyamide polymer.

In a different case, TFC polyamide printed membranes were made using 2% (w/v) MPD/water solution containing 2% triethylamine and 0.1% (w/v) sodium dodecylsulfate (SDS). This solution was added to all the tanks in the printer and “100% black” was then printed various number of times on the PSf ultrafiltration support. Once printed, the membranes were treated with 0.1% (w/v) TMC/n-hexane solution, similar to the conventional method.

### Interfacial Polymerization Printing on PES Ultrafiltration Supports After Soaking In MPD Solution

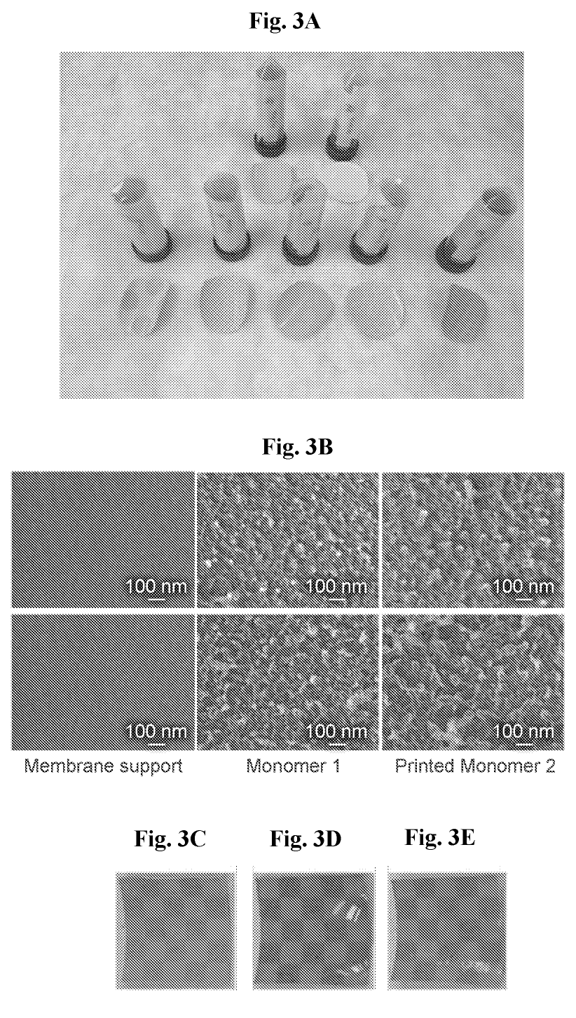

TFC polyamide printed membranes were made using 2% (w/v) MPD/water solution containing 5% ethylene glycol and 100 ppm Na₂CO₃ including 5% N-methyl-2-pyrrolidone (NMP). The membranes were pre-soaked in this solution for 5 min and were then rolled with a rubber roller to remove excess drops. This soaked support was printed using (a) 2% MPD solution in the C, M and Y ink reservoir tanks, and (b) 0.15% aqueous congo red solution in the K ink reservoir. Different “black and white” patterns were printed (FIG. 3). Once printed, the membranes were treated with 0.2% (w/v) TMC/n-hexane solution, similar to the conventional method. The “white” and “black” portions of the membrane were analyzed with SEM and different morphology and structure were observed in the areas with congo red. The nanostructure was approximately twice as large as the nanostructure of the polyamide polymer. Also, the parts of the membrane that incorporated congo red were more hydrophobic (contact angle 83°±6° compared with the areas that did not have congo red (contact angle 54°±5°. Congo red is a pH sensitive dye. After incorporation into the polyamide thin film with this process, the membrane was subjected to aqueous acid and base solutions. The membrane areas where the dye was incorporated changed to blue upon immersion in HCl solution, and back to red when immersed in NaOH solution. This color change process was repeated more than 50 times with no deterioration of the membrane or color, after which it was deemed to show robust switching properties.

### Interfacial Polymerization Printing on PSf Ultrafiltration Supports After Soaking In MPD Solution Using MPD and a Fluorinated Diamine

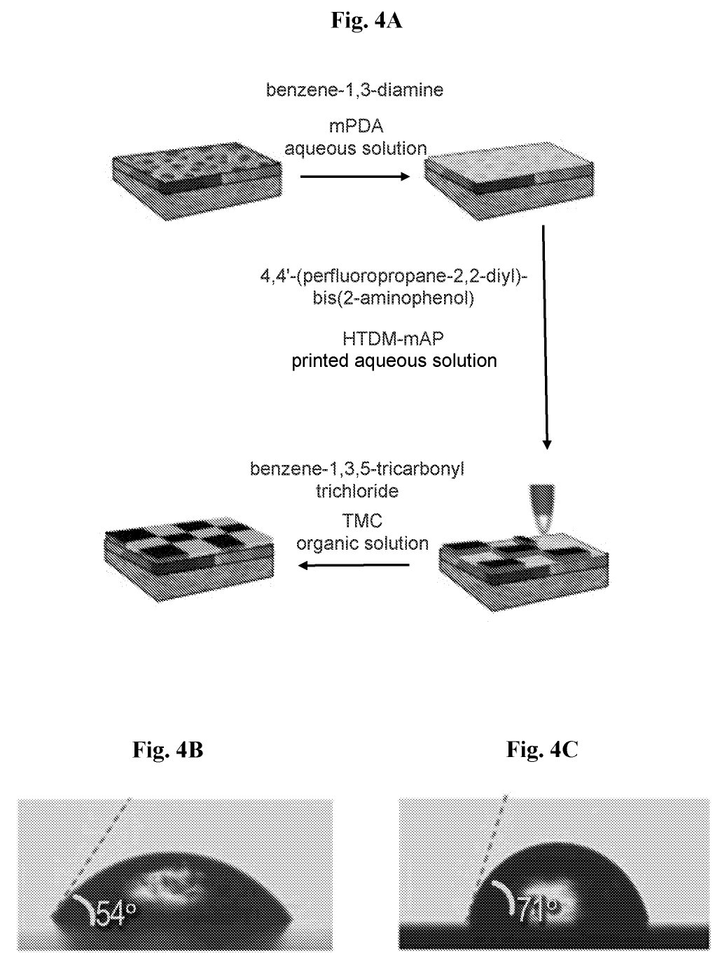

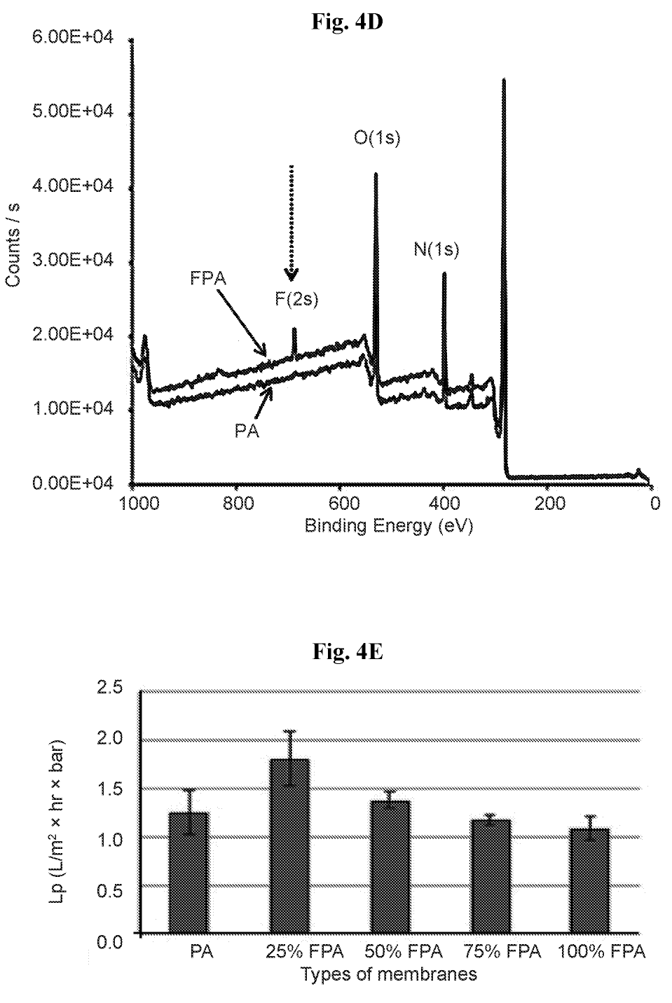

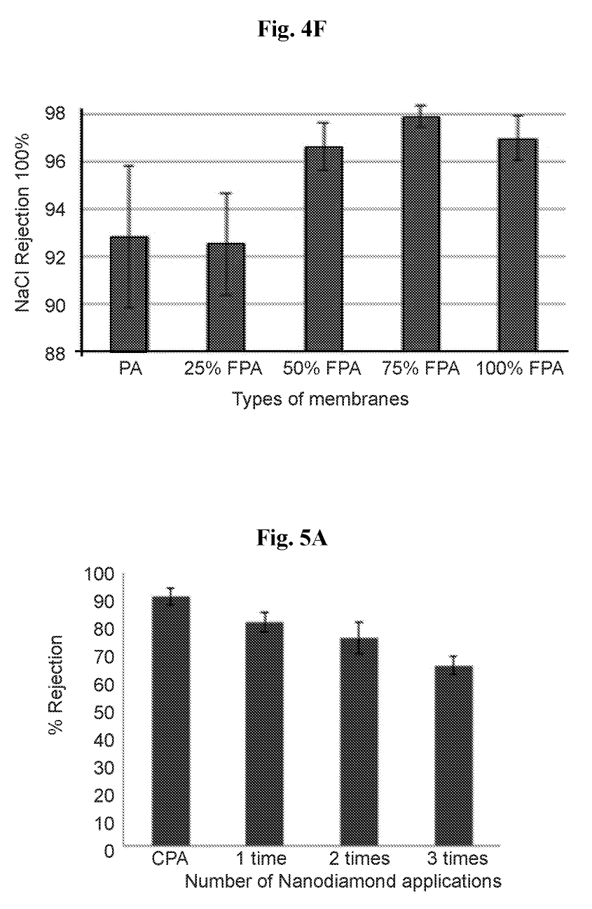

TFC polyamide printed membranes were made using 2% (w/v) MPD/water solution. As illustrated in FIG. 4A, the membranes were pre-soaked in this solution for 5 min and were then rolled with a rubber roller to remove excess drops. This soaked support was printed using (a) 5% 2,2-bis(3-amino-4-hydroxyphenyl)hexafluoropropane (a fluorinated diamine) in alkaline solution, in the K ink reservoir tank, and (b) Milli-Q water in the C, M and Y ink reservoir tanks. Different “black and white” patterns were printed (checkerboard patterns as shown in FIG. 3A). Once printed, the membranes were treated with 0.1% (w/v) TMC/n-hexane solution, similar to the conventional methods above. After 1 min, the TMC solution was decanted, and the resulting membrane was subsequently dried for 5 min in air at ambient temperature, rinsed with an aqueous 0.2% (w/v) Na₂CO₃ solution for 5 min, and stored in deionized (DI) water until use. The “white” and “black” portions of the membrane were analyzed with XPS analysis in order to confirm the new patterned fluorinated-polyamide that was formed on the surface, and as observed, a newly generated fluorine peak was formed (dashed arrow in FIG. 4D) due to the fluorine-containing diamine used, while the control membrane prepared without pattern printing of the fluorinated diamine showed only three major peaks originated from the regular aromatic polyamide. As shown in FIG. 4D, since the control membranes (PA) do not contain fluorine, no fluorine is observed in the XPS. On the other hand, in membranes printed with fluorinated diamine (FPA), fluorine is clearly detected, which is an indication of a successful reaction.

“Checkerboard” patterns were printed in which the membrane was 25%, 50%, 75% or 100% covered with the fluorinated diamine polymerized as described above. Contact angle was slightly increased in the fluorinated diamine covered areas (71°±4) as compared with MPD covered area (54°±5) (FIGS. 4C and 4B, respectively). Flux and salt rejection were measured for these membranes and an increase in salt rejection was generally observed (FIG. 4F) as the coverage of the fluorinated diamine increased: 0% fluorinated diamine FPA coverage gave NaCl rejection of about 92%, whereas increasing area of fluorinated diamine lead to NaCl rejection as high as 98%. Flux was measured to be similar or greater for fluorinated diamine membranes as compared to membranes fabricated without fluorinated diamine (FIG. 4E). Other advantages of fluorinated membranes might be increased chlorine resistance, increased boron rejections, increased salt rejections, and decreased scaling and biofouling.

### Interfacial Polymerization Printing on PSf Ultrafiltration Supports After Soaking In MPD Solution Using Amine-Functionalized Nanodiamonds

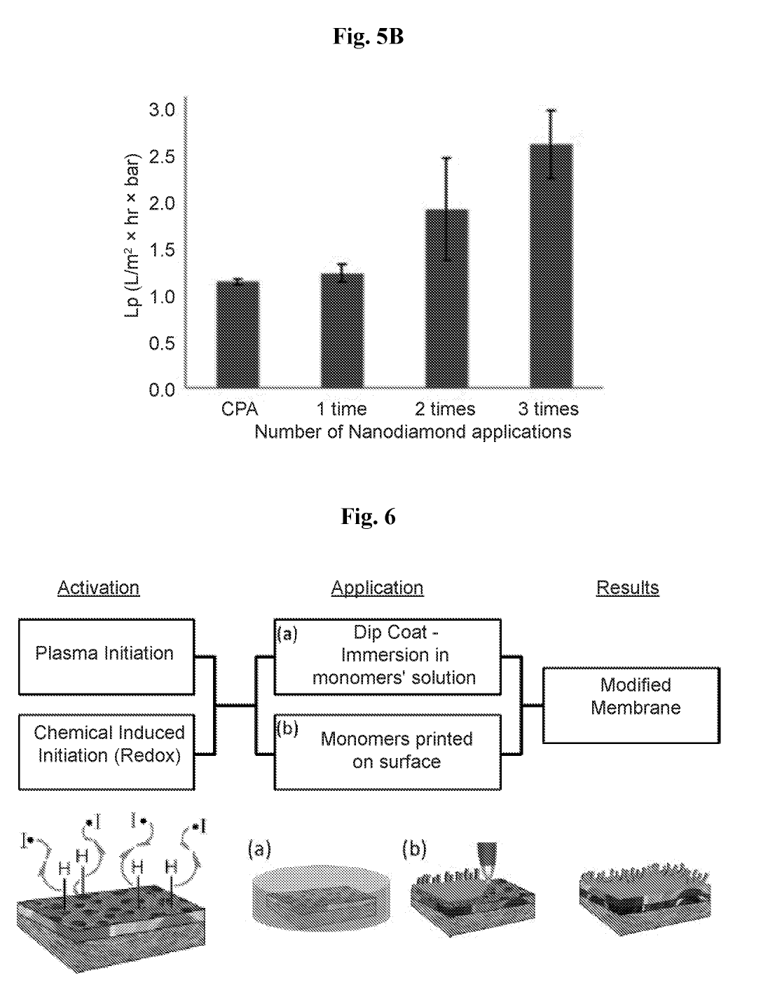

In this particular process, different polyfunctional amines, including nanoparticles, could be printed to give a variable polymer composition or polymer composite. The nanoparticles can be either amine-functionalized nanoparticles, e.g., amine functionalized nanodiamonds, to get covalent attachment, or non-functionalized to get composite material. For example, TFC polyamide printed membranes were made using 2% (w/v) MPD/water solution. The PSf ultrafiltration support membranes (PS-20, 20 kDa, Sepro) were pre-soaked in this solution for 5 min (excess droplets on the surface were removed). This soaked support was printed using 2.5% dispersed amine functionalized nanodiamonds aqueous solution (contains: amine modified surface nanodiamonds purchased from Ray Techniques Ltd., distilled water and “Paul Roark's Generic clear base C6A (distilled water, glycerol and Kodak photo-Flo 200 formula)), that was poured to all the ink reservoirs tanks (C, M, Y, K). “100% black” (designed by Adobe Photoshop CS6) as a full surface cover was then printed various number of times (1-3 times) on the PSf ultrafiltration support. Excess droplets on the printed surface were rolled flat with the soft rubber roller. Once printed, the membranes were treated with 0.1% (w/v) TMC/n-hexane solution, similar to the conventional method. After 1 min, the TMC solution was decanted, and the resulting membrane was rinsed with an aqueous solution of 0.2% (w/v) sodium carbonate and stored in DI water until use. Nanodiamonds were incorporated covalently into the polyamide matrix and a higher concentration of nanodiamonds (more prints) led to higher permeability and lower NaCl rejection (FIG. 5). This process may be useful for fabrication of catalytic surfaces or membranes where the catalysts are nanoparticles and differing permeability and flux are needed.

### Preliminary Membrane Testing Methods

Separation efficacy. Permeate-flux and salt-rejection of the membranes were measured using dead-end cell. The 25° C. aqueous feed contained 1500 or 2000 ppm (0.026 or 0.034 M, respectively) NaCl, and the pH was between 6 and 7 (the transmembrane pressure (TMP) difference was 19.5-20 bar and the permeate pressure was essentially atmospheric).

Contact Angle. Contact angles may be those of DI water at room temperature. Membranes may be thoroughly rinsed with water, and then allowed to dry in a vacuum desiccator to dryness. Due to the occasional variability in contact angle measurements, 6 angles were measured and averaged with reported standard deviation.

### Example 2

### Membrane Modification Via Ink-Jet Printing

In general, an Epson L110 printer was used with the front paper feed roller removed to prevent damage to the membrane surface. The middle portion of the rear roller was removed as well. Optionally, a flexible tube was attached onto the print head for application of nitrogen gas in the vicinity of the print head. Reverse osmosis membrane surfaces were activated with atmospheric plasma and printed a number of times with a monomer solution, at room temperature. The solution was composed of MA and PEGMA in a ratio of 4:1 in water (0.8 M MA and 0.2 M PEGMA). This solution was poured into the 4 color reservoirs of the Epson L110 printer instead of the CMYK inks. After reaction, the membrane was washed between 15-20 min with DI water with stirring. The membranes were dried at atmospheric pressure and room temperature. An overview of the activation, and coating application methods are schematically shown in FIG. 6.

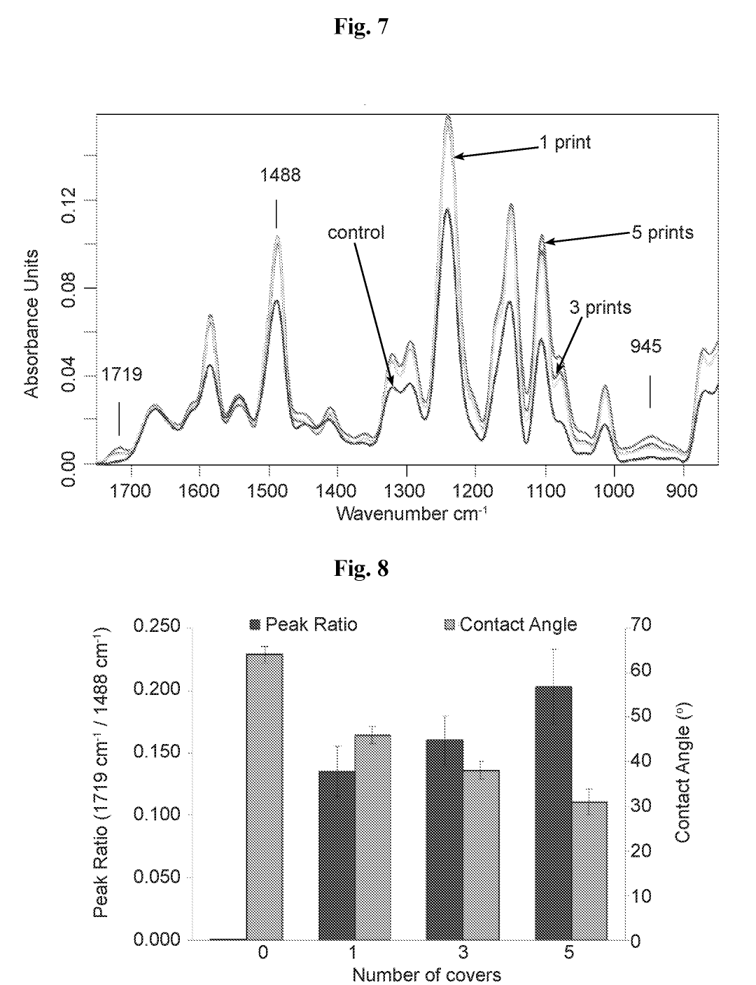

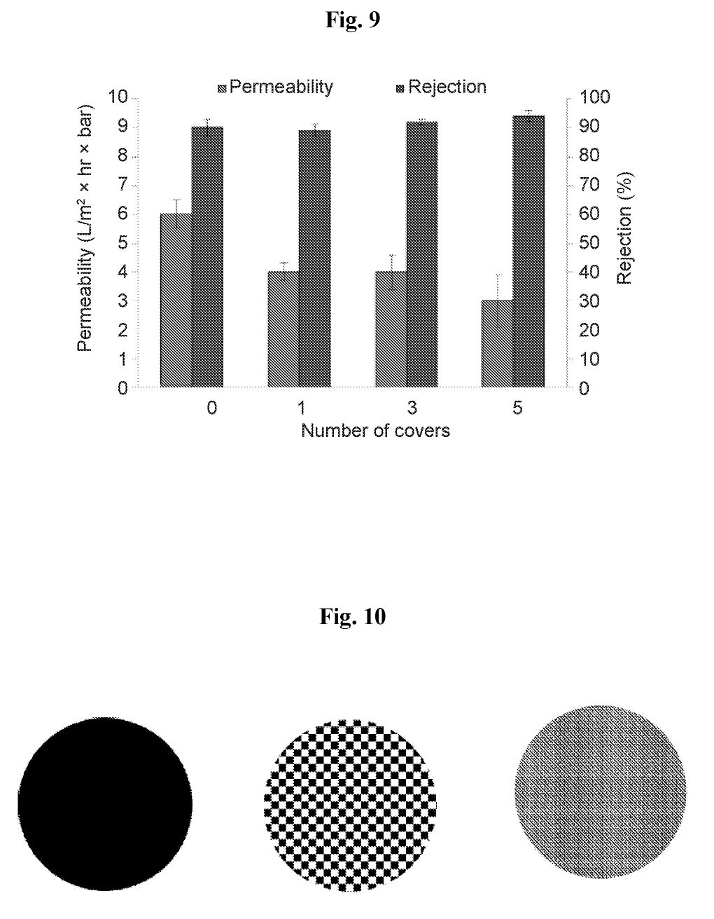

In particular, the surface of a commercially available reverse osmosis membrane (ESPA-1) was activated with atmospheric plasma (Surfx technologies) O₂ and He gas at 100 W, scanning at a rate of 40 mm/min and at a height of 1 to 3 cm from the wet membrane. Graft polymerization was then achieved by application of the monomers MA and PEGMA with the ink-jet printer. As shown in FIG. 7, the appearance of a new peak at value of about 1715 cm⁻¹ is an evidence of a successful graft polymerization. Accordingly, FTIR measurements showed that a polymer layer of increasing thickness was added to the surface of the membrane with an increasing number of prints, as determined by analysis of the characteristic signals of the new grafted layer polymer at ca. 1715 cm⁻¹ and at ca. 950 cm¹. A decrease of contact angle was also observed from 64° for the untreated membrane to about 30° as the number of prints increased (FIG. 8). Flux and rejection values were measured and salt rejection increased, and flux decreased as number of prints increased (FIG. 9).

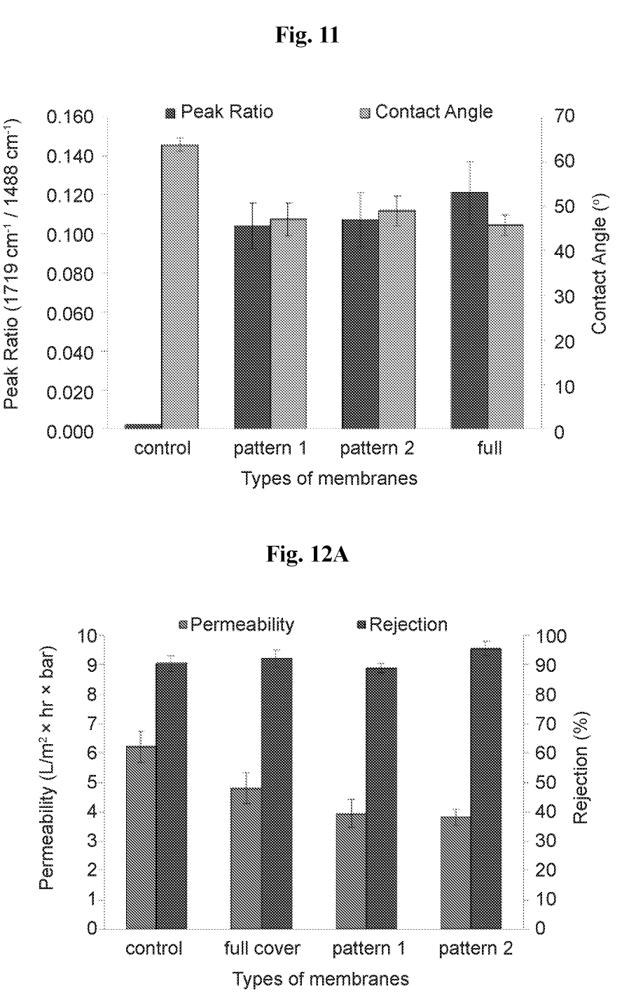

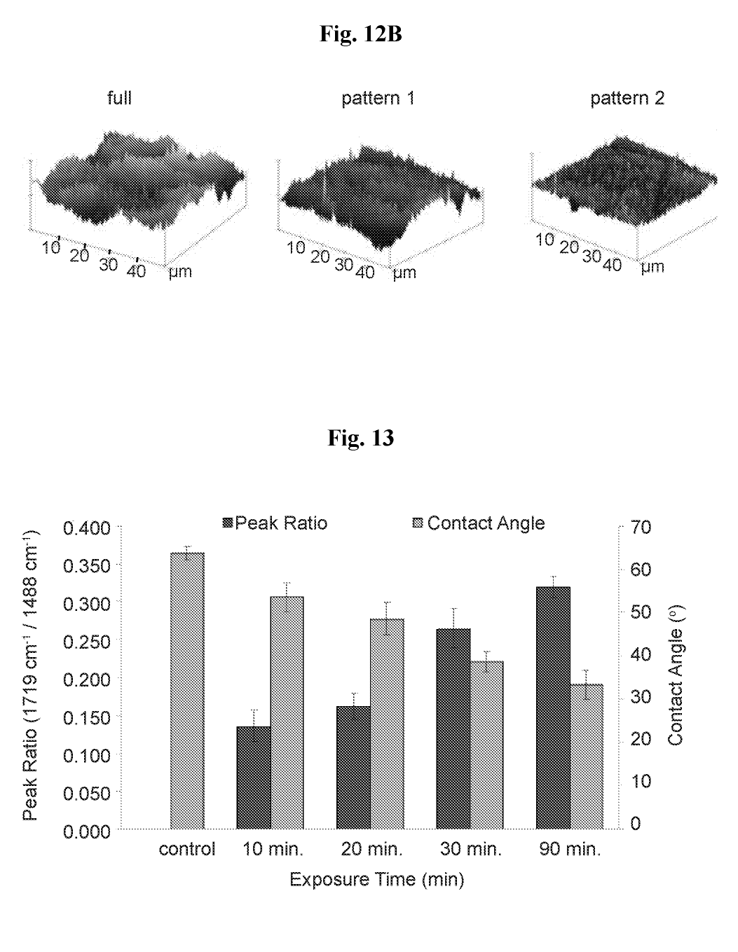

In particular, the surface of a commercially available reverse osmosis membrane (ESPA-1) was activated with atmospheric plasma (Surfx technologies) O₂ and He gas at 100 W, scanning at a rate of 40 mm/min and at a height of 1 cm from the wet membrane. Graft polymerization was then achieved by application of the monomers MA and PEGMA with the ink-jet printer printed as a full cover, a checkerboard pattern where printed areas comprised 50% of the membrane (“pattern 1”), and a zig-zag pattern where printed areas comprised 85% of the membrane (“pattern 2”) (FIG. 10). Similarly as above, the FTIR and contact angle changes indicated a successful reaction (FIG. 11). The flux decreased on modified membranes and the rejection remained the same or increased (FIG. 12A). Atomic force microscope (AFM) was used to give an indication of surface roughness, and the patterned membranes showed a smoother surface compared to the fully covered modified membrane as shown in FIG. 12B and summarized in Table 3.

TABLE 3

| | Roughness | Roughness |
|---|---|---|
| | Rₐ (nm) | RMS (nm) |
| Unmodified | 67 ± 2 | 85 ± 3 |
| Fully modified | 117 ± 4 | 166 ± 2 |
| Pattern 1 | 90 ± 2 | 135 ± 5 |
| Pattern 2 | 100 ± 1 | 133 ± 3 |

### Membrane Modification Using Ink Jet Printing and Redox Activation

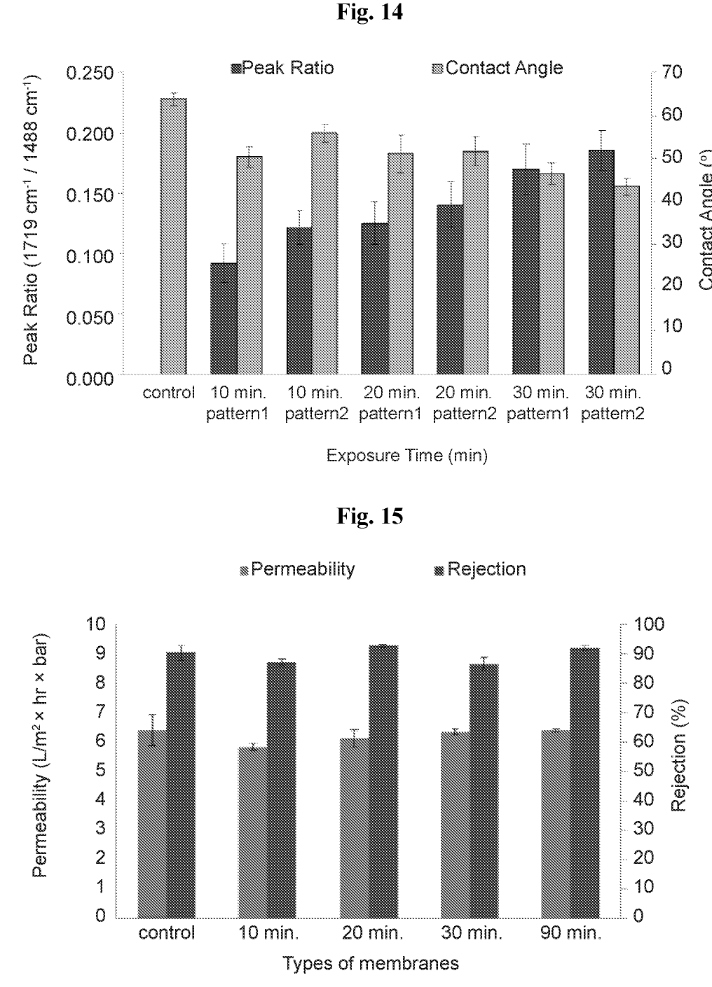

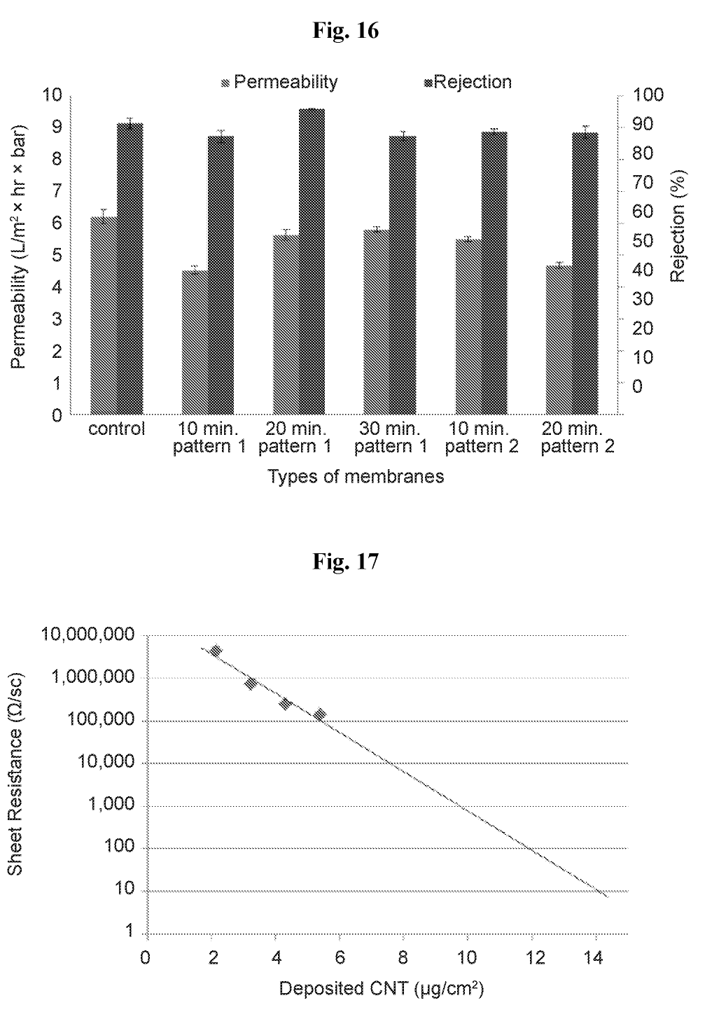

In general, an Epson L110 printer was used with the front paper feed roller removed to prevent damage to the membrane surface. The middle portion of the rear roller was removed as well. Reverse osmosis membrane surfaces were activated by soaking the membranes in aqueous solutions of potassium persulfate and potassium metabisulfite (equimolar concentration of 0.01M) for 10, 20, 30 and 90 minutes, and the membrane was then removed from the solution and loaded into the printer. A solution of monomers composed of MA and PEGMA in a ratio of 4:1 in water (0.8 M MA and 0.2 M PEGMA) was prepared at room temperature. This monomer solution was poured into the 4 color reservoirs of the Epson L110 printer instead of the CMYK inks, and was printed onto the potassium persulfate and potassium metabisulfite activated surface. One full covering was printed, as well as 50% covering in a checkerboard patterned manner (“Pattern 1”), and a 85% covering in a zig-zag pattern (“Pattern 2”) (FIG. 10). After printing, the membrane was kept in a closed petri dish container for 20 min, and was then washed for 15-20 min with DI water while stirring. The membranes were dried at atmospheric pressure and room temperature. FTIR and contact angle were measured on places where monomers were deposited. A general trend emerged, where increased FTIR 1720/1588 cm⁻¹ peak ratio correlated to a lower contact angle. In addition, an increased membrane soaking time in potassium persulfate and potassium metabisulfite solution gave increased modification (FIGS. 13-14). The membrane coupon size was 11.3 cm², and flux and rejection were measured. For the different activation times and different patterns printed, flux ranged from 88-135 L/m²·h with NaCl rejection of 82-96% (FIGS. 15-16). In general, these longer membrane-activation/soaking times gave increased roughness as observed in atomic force microscopy (AFM). In particular, while the root mean square (RMS) roughness measured for ESPA-1 control membrane was 84 nm, the RMS roughness measured for 10, 20 and 90 min activation/soaking was 154, 202, and 240 nm, respectively.

### Example 3

### Membrane Modification with Nanoparticles Using Ink-Jet Printing

In general, an Epson L110 printer is used with the front paper feed roller removed to prevent damage to the membrane surface. For disposal of excess solution, the ink pump is rerouted from the internal waste ink tank to an external container. 16 cm square membranes are taped to the center of laminated sheets of A4 paper preventing any part of the printer from physically touching the membranes. The middle portion of the rear roller is removed as well. Reverse osmosis membrane surfaces are used as the substrate to print a solution of CNTs (0.1-1.0 mg/ml) either as a full coverage coating (may be printed 1-50 times to increase CNTs density) or in different patterns, e.g., checkerboard or lines. For multiple printings, 5 minutes is allowed in between printings in order for the solution to dry, leaving only CNTs on the membrane before another layer is printed. The CNT solution is placed in one of the four ink reserve tanks, and a crosslinking solution, e.g., glutaraldehyde solution or other known crosslinkers, and a matrix solution, e.g., polyvinylalcohol solution or another suitable polymer, are placed in available ink reserve tanks. The three solutions are simultaneously printed on the reverse osmosis membrane. Heating of the membrane after printing may be necessary to allow crosslinker to completely react with the matrix and the CNTs, and temperatures from room temperature to about 100° C. may be used. Electrical conductivity of the surface due to the CNTs may prevent fouling upon application of an electric potential. Conductivity of modified membranes can be checked with a multimeter or, more accurately, with a four point conductivity meter. By printing multiple layers of CNTs on the polymer surface, increasing amounts of CNT-coated membranes could be achieved (FIG. 17). As a result, conductivity was increased as more CNTs were deposited.

In alternative processes, the membrane is pretreated with the matrix solution, and the CNT and crosslinking solutions are then printed on the pretreated membrane; or the membrane is pretreated with both the matrix and crosslinking solutions, and the CNT solution is then printed on the pretreated membrane. The matrix solution may also be mixed with the nanoparticle solution within the same ink tank. Alternatively in the crosslinking process the membrane can be submersed within a bath of crosslinker solution and heated.

Modification of membranes with nanoparticles as described above is not limited to CNT, and other nanoparticles such as silver, copper or titanium containing nanoparticles, nanodiamonds, graphene quantum dots, or other carbon-based nanoparticles, or any functionalized derivatives of those nanoparticles, can be utilized as well.

### Example 4

### Membrane Modification Via Stereolithographic Technique (Graft Polymerization Using Patterned UV Light)

### Experimental

Materials and reagents. The ultrafiltration membrane supports used were model UP010, or UH050, MWCO 10 kDa or 50 kDa, respectively) supplied by Microdyne Nadir (Germany). The following chemicals were purchased from Sigma-Aldrich (St. Louis, Mo., USA): N-(3-sulfopropyl)-N-methacryloyloxyethyl-N,N-dimethyl ammonium betaine (DMAB), PEGMA, MA, Irgacure 819 [Bis(2,4,6-trimethylbenzoyl)-phenylphosphineoxide], toluidine blue, and bovine serum albumin (BSA). All chemicals and solvents were used as received, unless otherwise noted. Deionized (DI) water was generated by a Milli-Q Advantage A10 water purification system (Millipore, Billerica, Mass., USA). A Pico Plus 27, 3-D DLP printer was purchased from Asiga (USA). All experiments were performed using a minimum of 4 membrane replicates, and the results were averaged. Standard error is reported.

Photo-initiated graft polymerization using a 3D printer. The experiments were performed at room temperature (ca. 24° C.). Membranes (UP010, 10 kDa MWCO) were cut to 35 mm by 22 mm and washed with DI water 3 times in an ultrasonic bath for 10 minutes, with the water being replaced after each washing. Next, membranes were soaked in a 50/50 solution of ethanol/water for 1 hour, then rinsed with water and stored at 4° C. in DI water. A monomer solution was prepared using 100 mM of MA and 400 mM of PEGMA in 100 ml of Milli-Q water and degassed by bubbling nitrogen through the solution for 15 minutes. The 3D printer was then connected to the PC's second VGA output and the display was cloned between both outputs. A completely white pattern was viewed full screen, the UV lamp was turned on and a piece of paper was placed in the printer to view the pattern and verify that it was properly projected. A custom made stage with a window was made in place of the transparent resin tray in order to place a glass petri dish, which included the monomer solution and the membrane to be irradiated. The UV image focus was adjusted manually on a test membrane before irradiation. Optimization of initiator concentration: The membrane was removed from the DI water storage solution, and blotted with a paper towel and allowed to air dry for 10 minutes. The membrane was soaked and protected from light for 1 min in the photoinitiator solution (0.05%, 0.1%, 0.5% or 1% irgacure 819 in methanol w/w) and air dried for 10 minutes. The membrane was then immersed in 20 ml of monomer solution in a petri dish, which was placed into the 3D printer on the custom built stage and immediately irradiated for one minute. Optimization of irradiation time: Membranes were immersed in irgacure 819 solution (1% w/w methanol) protected from light for one minute and air dried for 10 minutes, after which the membrane was irradiated for 15, 30, 45, and 60 seconds or 30 min as above. The control membranes consisted of 1) A membrane that was not soaked in irgacure 819, and irradiated in the 3D printer for 30 minutes, 2) A washed untreated membrane (no UV irradiation), and 3) A membrane that was soaked in the monomer solution for 30 minutes (no UV irradiation). The membranes were rinsed with DI water and soaked for at least 12 hours in DI water. Four replicates were performed. Optimization of washing method: Membranes (UH050, 50 kDa MWCO) were washed and prepared as above. The pure water flux was measured in the microfluidic cross flow system after 1 hour (3 bar, 2 ml/min/flowcell). As above, membranes were soaked in irgacure (1% w/w, methanol) for one minute, air dried for 10 minutes, and immersed in 20 ml of monomer solution in a petri dish, which was placed into the 3D printer and immediately irradiated with UV for 1 min. The membranes were then rinsed with DI water and immersed in aqueous washing solutions prepared with 0%, 1%, 10%, 20% or 50% ethanol by volume with sonication for 10 minutes. Membranes were removed and rinsed again with DI water before being stored in DI water at 4° C. The pure water flux was measured as before and normalized to the flux of the untreated membranes. Patterned membranes: The membranes were prepared as above; however, patterned images (100 μm, 150 μm, 300 μm, 1 mm and 2 mm stripes, striped diamonds, and sine waves) were projected onto the membrane. Visualization using toluidine blue: A toluidine blue solution (0.5 mM, 15 ml, pH 10) was prepared using an aqueous NaOH solution. A wetted membrane was blotted dry with a paper towel and immersed in the dye solution for 30 seconds, and washed in NaOH solution (pH 10) for 30 s by shaking. Membranes were air dried and viewed under a Zeiss Axio Imager Alm optical microscope at a magnification of 10×. The accompanying microscope software was used to take photographs and measure the dimensions that the dyed patterns exhibited. Variation of Polymer Chemistry: Three aqueous solutions were prepared using 100 mM of MA and 400 mM of PEGMA, 500 mM of PEGMA and 83 mM of N-(3-sulfopropyl)-N-methacryloyloxyethyl-N,N-dimethylammonium betaine, all in 20 ml of Milli-Q water. Solutions were degassed by bubbling nitrogen through the solution for 15 minutes. Membranes (UH050, 50 kDa MWCO) with 150 μm stripes were prepared as above, using irgacure (1% w/w in methanol) 15 s irradiation time, and washed with an aqueous solution of ethanol (50%). FTIR analysis: Membranes were dried in a dessicator for at least 6 hours and measured with FTIR (Parameters of a 1 cm⁻¹ resolution, 8 scans, and 2000-600 cm⁻¹ range). Five measurements from each membrane were performed and the absorbance ratio 1715 cm⁻¹/1586 cm⁻¹ was calculated. SEM Measurements: Four membranes were washed as describe above, soaked in irgacure 819 (1% w/w in methanol) for 1 min, air dried for 10 minutes, and rinsed with DI water. Membranes were vacuumed dried together with washed, unmodified control membranes for at least 6 hours. They were then viewed with a JEOL JSM-7400F SEM at a magnification of 50,000×.

Wastewater fouling method. A microfluidic system was used as previously described (Haas et al., 2015; Wardrip and Arnusch, 2016). Secondary treated wastewater was gathered from an aeration pond located at Kibbutz Sde Boker (Israel) and stored at 4° C. Chlorine was removed from 18 L of tap water by bubbling air through it for 48 hours before it was mixed with 1.8 L of wastewater. Four membranes of the same type were inserted into the flow cells and Milli-Q water was pumped through the system at a rate of 8 ml/min. The system pressure was automatically adjusted by the system until the average flux of the 4 membrane coupons was within 10% of 200 LMH. Any membrane with a flux difference greater than 20% of 200 LMH was replaced with a new membrane. Digital balances were zeroed, data-logging was started and pure water pumped through the system for one hour with the system set to automatically adjust the pressure to maintain an average 200 LMH flux. The pressure was then kept constant (see Table 4) as the feed was switched to the wastewater solution for 24 hours before stopping the data-logging. Immediately membranes were removed from the flow cells, placed in 1.5 ml Eppendorf tubes, and stored at −80° C. The system was flushed with a 70% ethanol solution for 15 minutes and then water for an additional minute. This process was repeated for each type of membrane with wastewater filtration times of 1, 8 and 24 hours.

DNA extraction and amplicon sequencing. DNA was extracted from microbial biomass on modified membrane and unmodified control membrane samples that represent samples taken at time points 1, 8, and 24 h, using the PowerSoil DNA Isolation kit (MoBio Laboratories) as per manufacturer's instructions. Extracted DNA was PCR amplified and sequenced using a modified version of the protocol presented in Caporaso et al. (2011), adapted for the Illumina HiSeq2000 and MiSeq. Briefly, the V4 region of the 16S rRNA gene was amplified with region-specific primers that included the Illumina flow cell adapter sequences. The amplification primers were adapted from the Caporaso et al. protocol (Caporaso et al., 2010) to include nine extra bases in the adapter region of the forward amplification primer that support paired-end sequencing on the HiSeq/MiSeq. All sequencing was performed at the Institute for Genomics and Systems Biology, Argonne National Laboratory. Sequence data was deposited at DDBJ/EMBL/GenBank under the accession number, SRP068452.

Sequence analyses. A modified sequence analyses pipeline comprising Quantitative Insights Into Microbial Ecology (QIIME v 1.9.0) and USEARCH were utilized to quality filter reads and cluster operational taxonomic units (OTUs) (Caporaso et al., 2010; Edgar, 2010). The commands utilized for this pipeline are as listed in (http://drive5.com/usearch/manual/uparse_cmds.html). The OTU table generated by the USEARCH pipeline was then analyzed in the QIIME environment. For these analyses, the OTU table was rarefied to 10,550 reads per sample. Alpha (Shannon, Simpson) and beta diversity (Bray-Curtis, weighted and unweighted UniFrac) analyses were performed using QIIME scripts, alpha_rarefaction.py and beta_diversity_through_plots.py, respectively. The raw data was plotted using ggplot and phyloseq (McMurdie and Holmes, 2013) packages in RStudio™. Analysis of similarities (ANOSIM) and distance-based redundancy analysis (db-RDA) were utilized to test for significant differences in beta diversity between membrane patterns and between surface chemistries. We used db-RDA models to evaluate the percent of variation explained by the different membrane modifications.

### Results

Membrane modification was conducted as described in Experimental, and began by soaking an ultrafiltration membrane in a methanolic solution of a radical photo initiator sensitive to the UV light in the digital light processing (DLP) 3D printer (405 nm). After evaporation of the methanol, the membrane was immersed in an aqueous solution of the monomers and patterned UV light was irradiated on the surface. The photo initiator adsorbed on the membrane surface ensured that radicals were generated near to the membrane surface in the monomer solution during grafting. Furthermore, the short reaction time (15 sec), and a very low water solubility of the initiator (<0.1 mg/100 ml water) would only give negligible initiator desorption into the aqueous monomer solution. The method was developed using a mixture of MA and PEGMA in a ratio of 1:4.

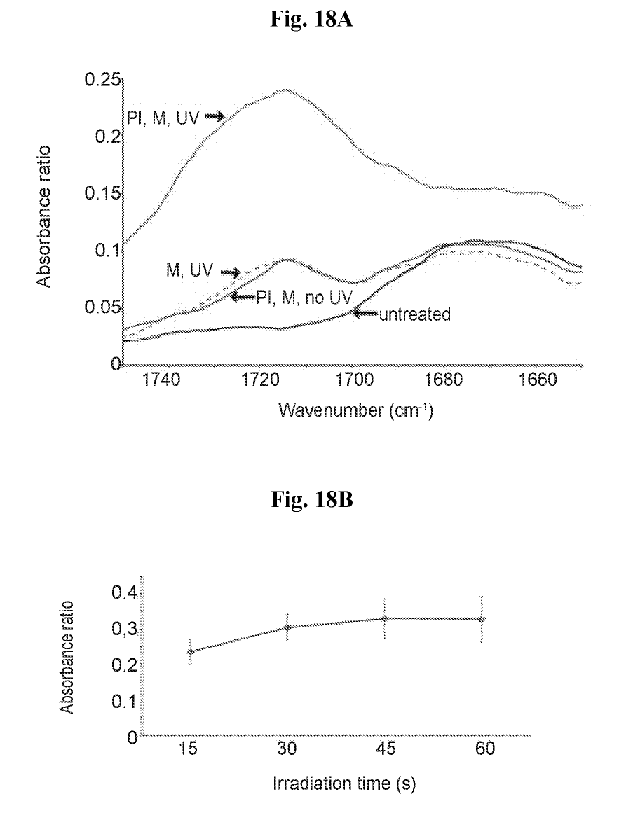

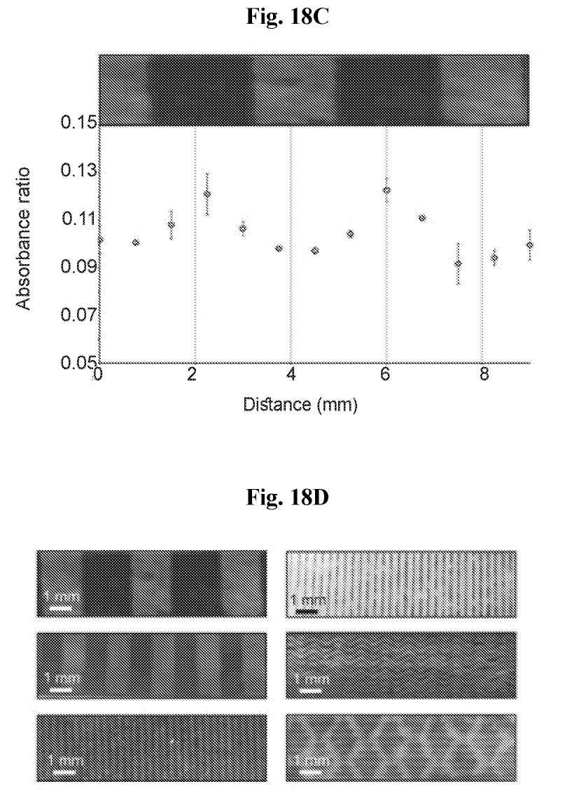

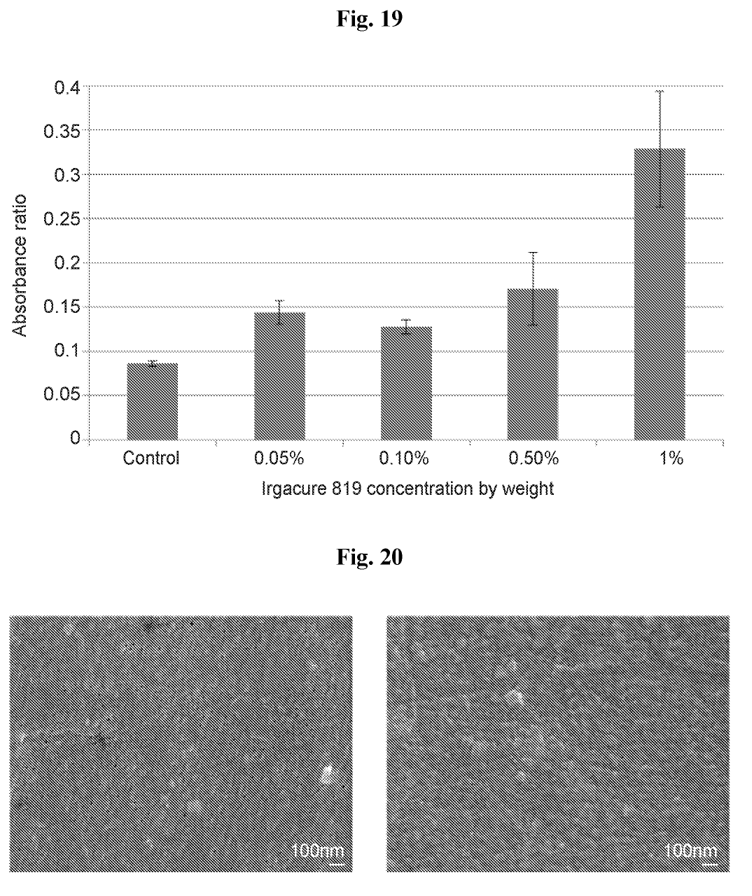

The amount of surface grafting was determined using an FTIR method whereby the ratio of the signals of the newly formed polymer layer to the underlying PSf layer gave an estimate of the polymer amount and thickness (Freger et al., 2002). Clearly, differences in the absorbance between 1750-1650 cm⁻¹/1586 cm⁻¹ showed that the photoinitiator was essential for efficient grafting (FIG. 18A). A control membrane soaked in monomers, but not irradiated with UV light, gave a similar FTIR absorbance signal to the irradiated membrane with no photoinitiator (˜0.09) and indicated slight non-covalent absorbance of the monomers onto the membrane, as the untreated control membrane gave a ratio of ˜0.03. Variation of the photoinitiator amount (0.05%, 0.1%, 0.5% or 1% irgacure 819 in methanol w/w) showed a significant increase in reaction efficiency. For example, FTIR absorbance ratio increased from 0.08 to 0.32 when 1% (w/w) was used (FIG. 19). The maximum grafting was achieved with 45 s irradiation time under these conditions (FIG. 18B). However, 15 s irradiation time would be deemed sufficient when future commercialization and possible need to scale up the method are considered. After grafting was complete, an essential washing step was performed with an aqueous ethanol solution (50% v/v) in order to remove non-covalently bound polymer, and the excess absorbed photoinitiator, since scanning electron microscopy showed that the membrane surface and pores were covered by the photoinitiator coating (FIG. 20). Next, the patterned polymer surfaces were analyzed with FTIR and visualized with toluidine blue, a dye that binds to the carboxylic acid component in the grafted layer. FTIR gave subtle, but clear differences between the irradiated and non-irradiated areas (FIG. 18C). Different patterns and designs as fine as 100 μm were attempted; however, we deemed that the maximum working resolution possible with our apparatus was ˜150 μm (FIG. 18D). Finally, a series of striped membranes using the optimized conditions of 1% initiator, and 15 s irradiation time were fabricated with three different polymer compositions: PEGMA realized a neutral polymer coating, a mixture of PEGMA and MA gave a negatively charged coating, and N-(3-sulfopropyl)-N-methacryloyloxyethyl-N,N-dimethyl ammonium betaine (DMAB) resulted in a neutral, zwitterionic coating.

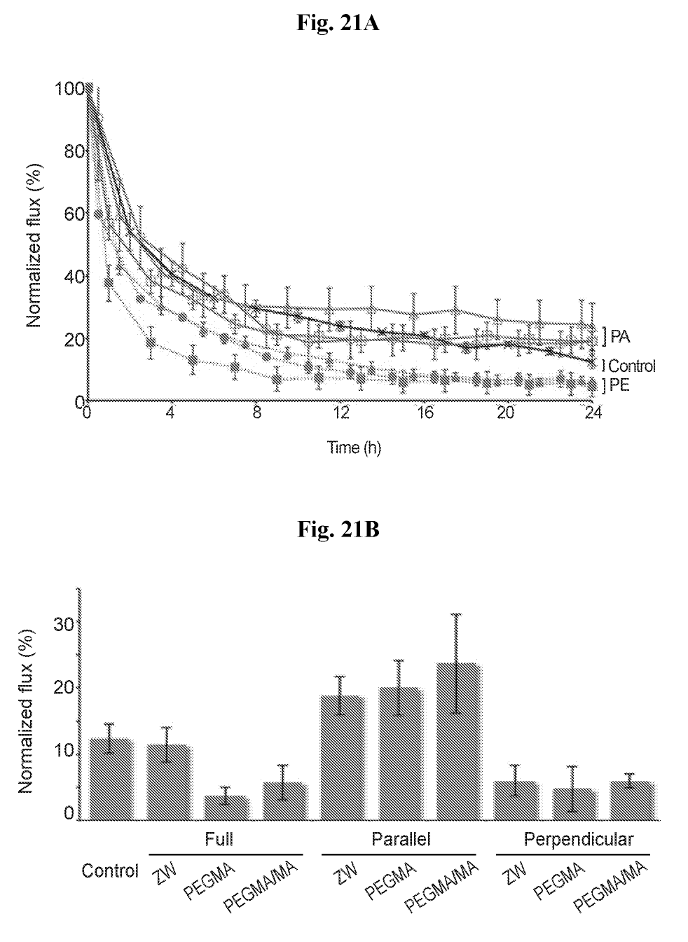

Membrane performance testing utilized a custom designed 3D printed flow cell (Haas et al., 2015; Wardrip and Arnusch, 2016), in which four membranes were tested in parallel. High initial flux conditions (200 LMH) were chosen to significantly accelerate membrane fouling (Ang and Elimelech, 2007; Shen et al., 2013; Jamshidi Gohari et al., 2013), and 24 hour fouling runs were performed at constant pressure with secondary treated wastewater. A reduction of flux indicated membrane fouling. We observed significant fouling differences especially between the membranes with different pattern orientation (FIG. 21). In all cases, modification of the membrane in a perpendicular striped pattern resulted in increased fouling compared to the unmodified membrane control. At the termination of the experiment, parallel stripes reduced the normalized flux the least (to 19-24% of the original value), compared to the unmodified membrane, with a final normalized flux of 13%, whereas the perpendicular stripes gave the highest reduction of flux, between 5-6% of the original value. In the present study, the testing was performed in a microfluidic channel, giving a low Reynolds number of 57 (laminar flow), but very high shear rate of 5000 s⁻¹. Fouling studies with variation of the shear rate and with different flow types may be important to understand pattern orientation effects and will be reported in due course.

The total resistance of the fouled membrane can be modeled in a resistance in series type model based on Darcy's law and is equal to the sum of the resistances of the cake layer, other fouling layers on the membrane and the membrane itself. Thus, the difference between the total resistance of the fouled membrane (Rₜ) and the initial membrane resistance before fouling (Rₘ) can give an indication of the resistance of the fouling layer and the cake layer (Table 4). Here we observed large differences between the perpendicular striped pattern and the parallel pattern, which gave average resistance differences of 27 and 6.7 respectively (×10¹² m⁻¹). Smaller differences were seen between the membranes with the same pattern but with different compositions, e.g., parallel patterned DMAB, PEGMA, and PEGMA-MA coatings gave resistance differences of 7.0, 7.9, and 5.1 respectively (×10¹² m⁻¹) The fouling and cake layer resistance for the parallel PEGMA-MA coating was found to be the smallest at 5.1×10¹² m⁻¹, giving a 15% reduction to the control membrane, which gave 6.0×10¹² m⁻¹. Noteworthy is that PEGMA-MA gave the largest fouling and cake layer resistance of 86×10¹² m⁻¹ in the case where the entire surface was modified, underlining the importance of the type and orientation of the patterned surface on fouling layer resistance. Under the initial hydrodynamic conditions (200 LMH), deposition of organic matter, and bacteria will occur quickly. Thus the chemical composition of the membrane surface may become less influential once covered with a conditioning layer of natural organic matter or other fouling substances, which may quickly overcome the relatively weak electrostatic interactions of the different the surfaces. However, we observe that the pattern remains an important factor.

TABLE 4
Pressure, normalized flux and calculated resistances of the patterned membranes

| | Surface | Pressure¹ | Flux² | Rₘ³ | Rₜ⁴ | Rₜ⁻Rₘ |
|---|---|---|---|---|---|---|
| Pattern | chemistry | (bar) | (%) | (×10¹² m⁻¹) | (×10¹² m⁻¹) | (×10¹² m⁻¹) |
| Full | DMAB | 2.7 | 23 | 4.9 | 43 | 38 |
| | PEGMA | 1.4 | 7.4 | 2.5 | 68 | 66 |
| | PEGMA-MA | 2.9 | 11 | 5.2 | 92 | 86 |
| Perpendicular | DMAB | 0.8 | 12 | 1.4 | 24 | 23 |
| | PEGMA | 1.0 | 9.4 | 1.8 | 38 | 36 |
| | PEGMA-MA | 0.8 | 12 | 1.4 | 24 | 23 |
| Parallel | DMAB | 0.9 | 38 | 1.6 | 8.6 | 7.0 |
| | PEGMA | 1.1 | 40 | 2.0 | 9.9 | 7.9 |
| | PEGMA-MA | 0.9 | 48 | 1.6 | 6.7 | 5.1 |
| Control | PSf | 0.5 | 26 | 0.9 | 6.9 | 6.0 |

¹pressure for pure water initial flux 200 LMH;
²final normalized flux after 24 h fouling with secondary treated wastewater at constant pressure;
³calculated resistance of the membrane;
⁴calculated total resistance at 24 h.

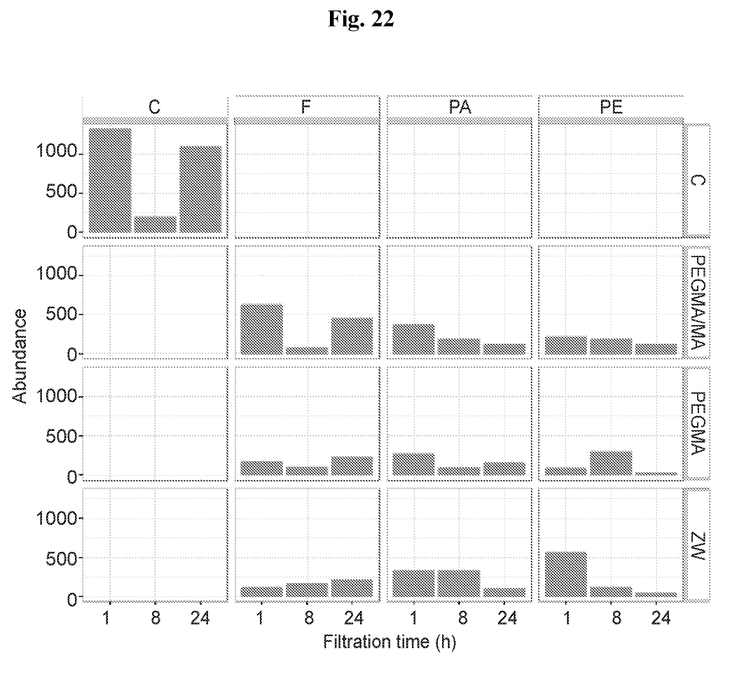

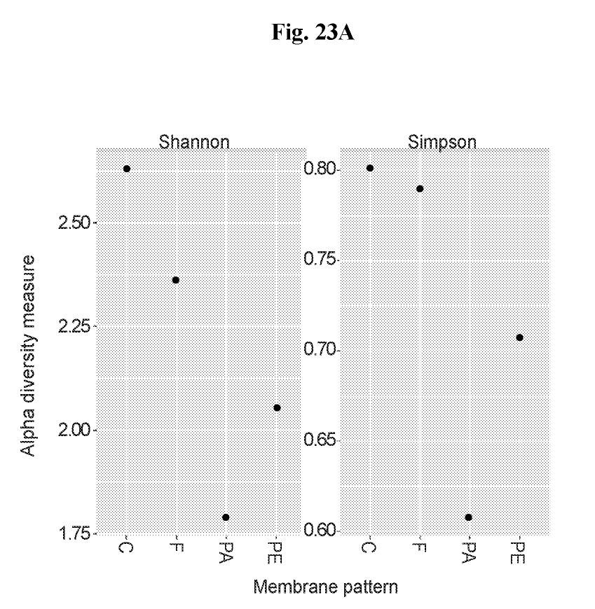

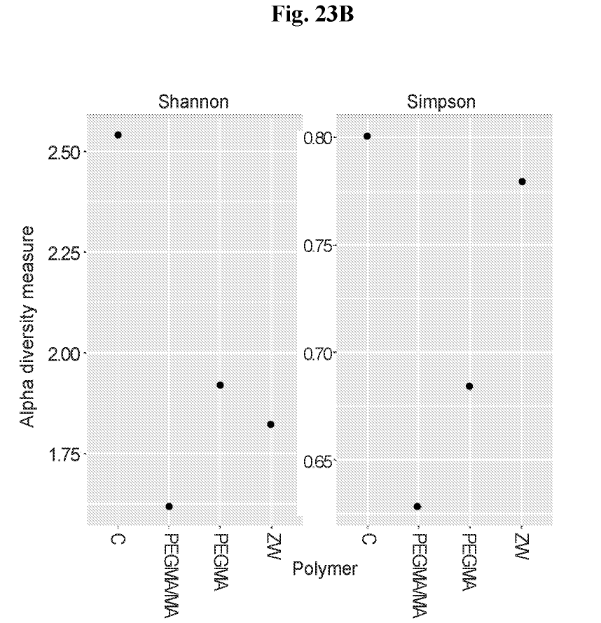

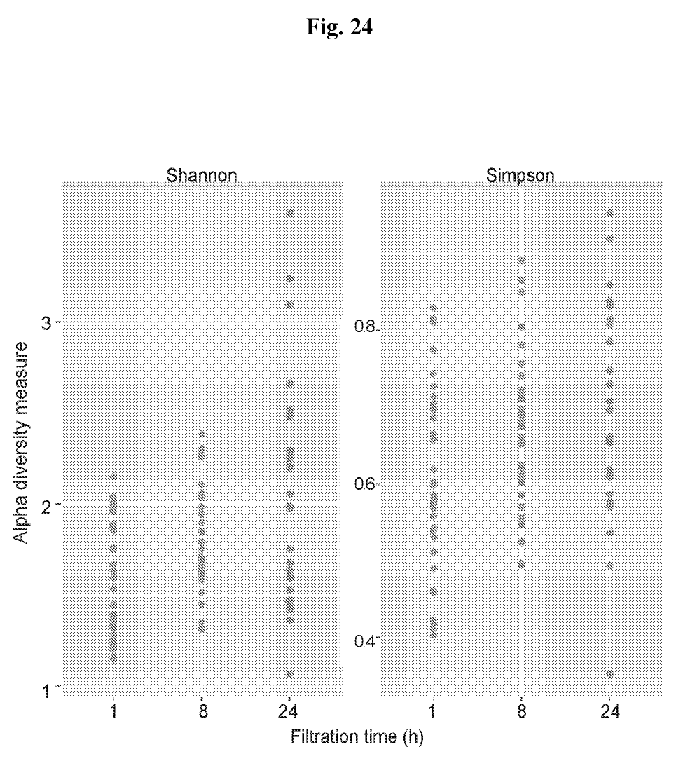

Following membrane performance testing, microbial biomass material was sampled from the membrane surfaces, and DNA was extracted. To characterize the microbial community structure and composition in response to treatment, a 16S rRNA amplicon sequencing approach was employed as detailed previously (Walters et al., 2015). Membrane samples at 1, 8, and 24 h were analyzed following 16S rRNA V4 amplicon sequence data generation, using Quantitative Insights Into Microbial Ecology (QIIME v.1.9.0) and USEARCH to quality filter reads and cluster operational taxonomic units (OTUs; 97% nucleotide identity) as previously described (Rideout et al., 2014; Edgar, 2010; Caporaso et al., 2010). Approximately 1.6 million high-quality 16S rRNA amplicons representing 720 unique OTUs were generated from 96 membrane samples. Actinobacteria, Bacteroidetes, Firmicutes, Proteobacteria, and Verrucomicrobia were the five most abundant bacterial phyla, comprising ˜99% of all reads. Acinetobacter was the most abundant bacterial genus, comprising ˜77% of all sequence reads. Studies investigating pioneer bacterial species responsible for biofouling in membrane bioreactors also identified several members of Acinetobacter in their samples (Zhang et al., 2006). The ability of bacteria to move on surfaces has been reported to play an important role in encouraging surface colonization and biofilm maturation (Harshey, 2003). Surface movement of Acinetobacter spp. due to Type IV pili implicates that this species may be an important pioneer bacterial population. Members of the genus Sphingomonas (comprising ˜1% of all sequence reads) were depleted in all modified membranes compared to unmodified membrane controls (FIG. 22). Sphingomonas spp. have been implicated to form an important component of the pioneer bacterial population. It was shown that components of these bacteria, such as glycosphingolipids, may condition membrane surfaces, mediating cellular adhesion and enhancing attachment of biofilm-forming bacteria (Haas et al., 2015). Overall, we observed a reduction in bacterial alpha diversity across all modified membranes as measured by Shannon and Simpson diversity indices (FIG. 23). For example, comparing polymers types, and patterns, the Shannon diversity indices ranged between 1.89-2.13, and 1.79-2.36 vs. control (2.63), while the Simpson diversity indices ranged between 0.63-0.78 and 0.61-0.79 vs. control (0.8), respectively. However, a significant increase in bacterial diversity was observed from 1 h to 24 h (p<0.05) across all membrane types (FIG. 24). For 1 h, 8 h, and 24 h, Shannon indices ranged between 1.15-2.15, 1.32-2.38, and 1.07-3.6, while Simpson indices ranged between 0.4-0.83, 0.49-0.89, and 0.35-0.95. At the termination of the experiment, membranes with parallel stripes had the lowest bacterial diversity (Shannon, 1.79). Likewise, of all surface chemistries, the net negatively charged polymer at neutral pH, PEGMA-MA produced the lowest bacterial diversity (Shannon, 1.89). In both cases, observed bacterial diversities were significantly lower compared to unmodified membrane controls (p<0.05). Overall bacterial composition and structure was significantly different between all the membrane patterns, and between all the membrane chemistries (ANOSIM and distance-based redundancy analyses using Bray-Curtis, weighted and unweighted UniFrac, p<0.01). Bacterial community clustering was relatively indistinct when arrayed by PCoA (across just the first 2 principle coordinates), but samples showed significant clustering by surface chemistry. Bacterial community types that preferentially select membrane or other surfaces with variable chemistries or patterns may influence the rate and volume of the biofilm since the conditioning film and initial colonizing species have been shown to be a significant factor in initial bacterial attachment and fouling (Haas et al., 2015). Moreover, this knowledge could lead to optimization of the surface chemistry to treat waters with various microbial community compositions.

### REFERENCES

Ang, W.; Elimelech, M. Protein (BSA) fouling of reverse osmosis membranes: implications for wastewater reclamation. J. Memb. Sci. 2007, 296(1-2), 83-92

Caporaso, J. G.; Kuczynski, J.; Stombaugh, J.; Bittinger, K.; Bushman, F. D.; Costello, E. K.; Fierer, N.; Peña, A. G.; Goodrich, J. K.; Gordon, J. I.; Huttley, G. A.; Kelley, S. T.; Knights, D.; Koenig, J. E.; Ley, R. E.; Lozupone, C. A.; McDonald, D.; Muegge, B. D.; Pirrung, M.; Reeder, J.; Sevinsky, J. R.; Turnbaugh, P. J.; Walters, W. A.; Widmann, J.; Yatsunenko, T.; Zaneveld, J.; Knight, R. QIIME allows analysis of high-throughput community sequencing data. Nat. Methods 2010, 7(5), 335-336

Caporaso, J. G.; Lauber, C. L.; Walters, W. A.; Berg-Lyons, D.; Lozupone, C. A.; Turnbaugh, P. J.; Fierer, N.; Knight, R. Global patterns of 16S rRNA diversity at a depth of millions of sequences per sample. Proc. Natl. Acad. Sci. U.S.A. 2011, 108 Suppl (Supplement_1), 4516-4522

Edgar, R. C. Search and clustering orders of magnitude faster than BLAST. Bioinformatics 2010, 26(19), 2460-2461

Efimenko, K.; Finlay, J.; Callow, M. E.; Callow, J. A.; Genzer, J. Development and testing of hierarchically wrinkled coatings for marine antifouling. ACS Appl. Mater. Interfaces 2009, 1(5), 1031-1040

Eshet, I.; Freger, V.; Kasher, R.; Herzberg, M.; Lei, J.; Ulbricht, M. Chemical and physical factors in design of antibiofouling polymer coatings. Biomacromolecules 2011, 12(7), 2681-2685

Freger, V.; Gilron, J.; Belfer, S. TFC polyamide membranes modified by grafting of hydrophilic polymers: An FT-IR/AFM/TEM Study. J. Memb. Sci. 2002, 209(1), 283-292

Gu, M.; Vegas, A. J.; Anderson, D. G.; Langer, R. S.; Kilduff, J. E.; Belfort, G. Combinatorial synthesis with high throughput discovery of protein-resistant membrane surfaces. Biomaterials 2013, 34(26), 6133-6138

Haas, R.; Gutman, J.; Wardrip, N. C.; Kawahara, K.; Uhl, W.; Herzberg, M.; Arnusch, C. J. Glycosphingolipids enhance bacterial attachment and fouling of nanofiltration membranes. Environ. Sci. Technol. Lett. 2015, 2 (2), 43-47

Harshey, R. M. Bacterial motility on a surface: many ways to a common goal. Annu. Rev. Microbiol. 2003, 57, 249-273

Imbrogno, J.; Williams, M. D.; Belfort, G. A new combinatorial method for synthesizing, screening, and discovering antifouling surface chemistries. ACS Appl. Mater. Interfaces 2015, 7(4), 2385-2392

Jamshidi Gohari, R.; Lau, W. J.; Matsuura, T.; Ismail, A. F. Effect of surface pattern formation on membrane fouling and its control in phase inversion process. J. Memb. Sci. 2013, 446, 326-331

Jhong, J.-F.; Venault, A.; Hou, C.-C.; Chen, S.-H.; Wei, T.-C.; Zheng, J.; Huang, J.; Chang, Y. Surface zwitterionization of expanded poly(tetrafluoroethylene) membranes via atmospheric plasma-induced polymerization for enhanced skin wound healing. ACS Appl. Mater. Interfaces 2013, 5(14), 6732-6742

Ke, X.; Hongqiang, R.; Lili, D. A review of membrane fouling in municipal secondary effluent reclamation. Environ. Sci. Pollut. Res. 2013, 20(2), 771-777

Li, Q.; Imbrogno, J.; Belfort, G.; Wang, X.-L. Making polymeric membranes antifouling via “grafting from” polymerization of zwitterions. J. Appl. Polym. Sci. 2015, 132(21), 41781

Liang, S.; Kang, Y.; Tiraferri, A.; Giannelis, E. P.; Huang, X.; Elimelech, M. Highly hydrophilic polyvinylidene fluoride (PVDF) ultrafiltration membranes via postfabrication grafting of surface-tailored silica nanoparticles. ACS Appl. Mater. Interfaces 2013, 5(14), 6694-6703

Lin, N.; Kim, M.; Lewis, G.; Cohen, Y. Polymer surface nano-structuring of reverse osmosis membranes for fouling resistance and improved flux performance. J. Mater. Chem. 2010, 20, 4642-4652

Mauter, M. S.; Wang, Y.; Okemgbo, K. C.; Osuji, C. O.; Giannelis, E. P.; Elimelech, M. Antifouling ultrafiltration membranes via post-fabrication grafting of biocidal nanomaterials. ACS Appl. Mater. Interfaces 2011, 3(8), 2861-2868

McMurdie, P. J.; Holmes, S. Phyloseq: An R package for reproducible interactive analysis and graphics of microbiome census data. PLoS One 2013, 8(4), e61217

Nguyen, T.; Roddick, F. A.; Fan, L. Biofouling of water treatment membranes: A review of the underlying causes, monitoring techniques and control measures. Membranes 2012, 2(4), 804-840

Rana, D.; Matsuura, T. Surface modifications for antifouling membranes. Chem. Rev. 2010, 110, 2448-2471

Rideout, J. R.; He, Y.; Navas-Molina, J. A.; Walters, W. A.; Ursell, L. K.; Gibbons, S. M.; Chase, J.; McDonald, D.; Gonzalez, A.; Robbins-Pianka, A.; Clemente, J. C.; Gilbert, J. A.; Huse, S. M.; Zhou, H.-W.; Knight, R.; Caporaso, J. G. Subsampled open-reference clustering creates consistent, comprehensive OTU definitions and scales to billions of sequences. PeerJ 2014, 2, e545

Shen, X.; Zhao, Y.; Feng, X.; Bi, S.; Ding, W.; Chen, L. Improved antifouling properties of PVDF membranes modified with oppositely charged copolymer. Biofouling 2013, 29(3), 331-343

Vanysacker, L.; Declerck, P.; Vankelecom, I. Development of a high throughput cross-flow filtration system for detailed investigation of fouling processes. J. Memb. Sci. 2013, 442, 168-176

Walters, W.; Hyde, E. R.; Berg-Lyons, D.; Ackermann, G.; Humphrey, G.; Parada, A.; Gilbert, J. A.; Jansson, J. K.; Caporaso, J. G.; Fuhrman, J. A.; Apprill, A.; Knight, R. Improved bacterial 16S rRNA gene (V4 and V4-5) and fungal internal transcribed spacer marker gene primers for microbial community surveys. mSystems 2015, 1(1), e00009-e00015

Wardrip, N. C., Arnusch, C. J. Three-dimensionally printed microfluidic cross-flow system for ultrafiltration/nanofiltration membrane performance testing. J. Vis. Exp. 2016, e53556, doi:10.3791/53556 (in press)

Ye, G.; Lee, J.; Perreault, F.; Elimelech, M. Controlled architecture of dual-functional block copolymer brushes on thin-film composite membranes for integrated “defending” and “attacking” strategies against biofouling. ACS Appl. Mater. Interfaces 2015, 7(41), 23069-23079

Zhang, K.; Choi, H.; Dionysiou, D. D.; Sorial, G. A.; Oerther, D. B. Identifying pioneer bacterial species responsible for biofouling membrane bioreactors. Environ. Microbiol. 2006, 8(3), 433-440

1. A method for fabrication of a membrane for reverse osmosis, nanofiltration or ultrafiltration by forming either a polyamide layer or a nanoparticle layer on a surface of a support membrane, said method comprising a step selected from:
(i) ink-jet printing on said surface of said support membrane a polyfunctional amine or polyamine functionalized nanoparticles which, upon reacting on said surface with a polyfunctional acyl halide or anhydride functional group, forms said polyamide layer; or
(ii) ink-jet printing on said surface of said support membrane nanoparticles which, upon reacting on said surface with a matrix and a crosslinker, forms said nanoparticle layer.

2. The method of claim 1, wherein said support membrane is a polymer membrane.

3. The method of claim 1, wherein the membrane fabricated has salt rejection of 40-99.5%, and flux of 0.3-40 L/h m² bar.

4. The method of claim 1, for fabrication of a thin film composite (TFC) polyamide membrane, said method comprising:
(i) ink-jet printing of an aqueous solution of a polyfunctional amine or polyamine functionalized nanoparticles on a surface of a support membrane; and
(ii) treating the printed surface of said support membrane with a water-immiscible organic solution of a polyfunctional acyl halide or anhydride functional group thereby interfacially polymerizing said polyfunctional amine or polyamine functionalized nanoparticles with said polyfunctional acyl halide or anhydride functional group on said surface of said support membrane, thus forming a polyamide layer on said surface of said support membrane.

5. The method of claim 4, wherein step (i) is repeated n times prior to step (ii), and wherein n is an integer of 1 to 5.

6. The method of claim 4, wherein:
a) said ink-jet printing is carried out from (i) one reservoir; or (ii) more than one reservoir, wherein each one of said reservoirs contains an aqueous solution of identical or different polyfunctional amine or polyamine functionalized nanoparticles; or
b) said ink-jet printing is carried out according to a predetermined pattern.

7. The method of claim 4, wherein said treating in step (ii) is conducted by immersing the printed surface of said support membrane in said organic solution; or by ink-jet printing of said organic solution on the printed surface of said support membrane.

8. The method of claim 7, wherein:
a) said ink-jet printing is carried out from (i) one reservoir; or (ii) more than one reservoirs, wherein each one of said reservoirs contains an organic solution of identical or different polyfunctional acyl halide or anhydride functional group; or
b) said ink-jet printing is carried out according to a predetermined pattern.

9. The method of claim 7, wherein said treating in step (ii) is conducted by ink-jet printing of said organic solution on the printed surface of said support membrane, and simultaneously with said ink-jet printing of step (i).

10. The method of claim 4, wherein heat treatment is applied in step (ii) to complete the interfacial polymerization.

11. The method of claim 4, wherein:
(i) said support membrane is composed of polysulfone (PSf), polyethersulfone (PES), polyacrylonitrile (PAN), polyester, polyphenyleneoxide, polyphenylenesulfide, polyvinyl chloride, polyvinylidine fluoride, polytetrafluoroethylene, polycarbonate, polyetherketone, or polyetheretherketone; or
(ii) said polyfunctional amine is m-phenylenediamine (MPD), p-phenylenediamine, 2,4-diaminotoluene, 2,5-diaminotoluene, N,N′-diphenylethylene diamine, 4-methoxy-m-phenylenediamine, 1,3,4-triaminobenzene, 1,3,5-triaminobenzene, 3,5-diaminobenzoic acid, 2,4-diaminoanisole, xylylenediamine, ethylenediamine, propylenediamine, tris(2-diaminoethyl)amine, piperazine, a fluorinated aromatic polyamine, a fluorinated non-aromatic polyamine, a fluorinated alkane substituted with one or more aromatic groups each containing at least one amino group, a fluorinated alkane diol interrupted by one or more aromatic groups each containing at least one amino group, a chiral polyamine, or a mixture thereof; or
(iii) said nanoparticles are carbon nanotubes (CNTs), metallic nanoparticles, nanodiamonds, or graphene quantum dots; or
(iv) said polyfunctional acyl halide is trimesoyl chloride (TMC), trimellitic acid chloride, terephthaloyl chloride, isophthalolyl chloride, cyclohexane-1,3,5-tricarbonyl chloride, 1,3,5,7-tetracarbonyl chloride, adamantane-2,6-dione, 1-i socyanato-3,5-benzenedicarbonyl chloride (5-i socyanato-isophthaloyl chloride), an aromatic polyfunctional acyl halide, an alicyclic polyfunctional acyl halide, or a mixture thereof; or
(v) said anhydride functional group is a polyfunctional acid anhydride, or a polyfunctional acid anhydride halide; or
(vi) the organic solvent in said organic solution comprises a straight or iso-(C₅-C₁₂)alkane, a (C₅-C₁₂)cycloalkane, or a mixture thereof such as Isopar™ G Fluid, wherein said (C₅-C₁₂)alkane and (C₅-C₁₂)cycloalkane is optionally halogenated.

12. The method of claim 11, wherein:
(i) said fluorinated aromatic polyamine is 5-fluoro-m-phenylenediamine or 2,5-difluoro-m-phenylenediamine;
(ii) said fluorinated alkane substituted with one or more aromatic groups each containing at least one amino group is 2,2-bis(3-amino-4-hydroxyphenyl)hexafluoropropane;
(iii) said fluorinated alkane diol interrupted by one or more aromatic groups each containing at least one amino group is 2,2′-(methylenebis(3-amino-6,1-phenylene))bis(1,1,1,3,3,3-hexafluoropropan-2-ol);
(iv) said metallic nanoparticles are silver, copper or titanium containing (titanium dioxide) nanoparticles;
(v) said aromatic polyfunctional acyl halide is trimesic acid chloride, terephthalic acid chloride, isophthalic acid chloride, biphenyl dicarboxylic acid chloride or naphthalene dicarboxylic acid dichloride;
(vi) said alicyclic polyfunctional acyl halide is cyclopropane tricarboxylic acid chloride, cyclobutane tetracarboxylic acid chloride, cyclopentane tricarboxylic acid chloride, cyclopentane tetracarboxylic acid chloride, tetrahydrofuran tetracarboxylic acid chloride, cyclopentane dicarboxylic acid chloride, cyclobutane dicarboxylic acid chloride, cyclohexane dicarboxylic acid chloride or tetrahydrofuran dicarboxylic acid chloride;
(vii) said polyfunctional acid anhydride is mellitic anhydride;
(viii) said polyfunctional acid anhydride halide is 4-chloroformyl phthalic anhydride;
(ix) said (C₅-C₁₂)alkane is pentane, isopentane, hexane, isohexane, heptane, isoheptane, octane, isooctane, nonane, isononane, decane, isodecane, undecane isoundecane, dodecane, or isododecane; or
(x) said (C₅-C₁₂)cycloalkane is cyclopentane, cyclohexane, cycloheptane, cyclooctane, cyclononane, cyclodecane, cycloundecane or cyclododecane.

13. The method of claim 4, wherein the polyamide layer formed on said surface of said support membrane has a thickness in the range of 0.01-1 μm.

14. The method of claim 4, wherein said support membrane is soaked in an aqueous solution of a polyfunctional amine or polyamine functionalized nanoparticles prior to step (i).

15. The method of claim 14, wherein:
a) the concentration of said aqueous solution is in a range of 0.5-10% (w/v %); or
b) the polyfunctional amine or polyamine functionalized nanoparticles in the aqueous solution ink-jet printed in step (i) and the polyfunctional amine or polyamine functionalized nanoparticles in the aqueous solution in which the surface of said support membrane is soaked prior to step (i) are identical or different.

16. The method of claim 4, comprising the steps of:
(i) ink-jet printing of an aqueous solution of MPD or 2,2-bis(3-amino-4-hydroxyphenyl)hexafluoropropane on a surface of a porous support membrane n times, wherein n is an integer of 1 to 5, and said support membrane is composed of PSf, PES or PAN; and
(ii) treating the printed surface of said support membrane with a solution of TMC in n-hexane thereby interfacially polymerizing said MPD with said TMC on the surface of said support membrane, thus forming a polyamide layer on said surface of said support membrane.

17. The method of claim 16, wherein said support membrane is soaked in an aqueous solution of MPD prior to step (i).

18. The method of claim 1, for fabrication of a membrane coated with nanoparticles, said method comprising ink-jet printing of a solution of said nanoparticles on a surface of a support membrane to thereby form, upon reaction of said nanoparticles with a matrix and a crosslinker, a nanoparticle layer on said surface of said support membrane,
wherein (i) a matrix solution comprising said matrix and a crosslinking solution comprising said crosslinker are ink-jet printed on said surface of said support membrane simultaneously with said nanoparticle solution; or (ii) said surface of said support membrane is pretreated with said matrix solution, and said crosslinking solution is ink-jet printed on said surface of said support membrane simultaneously with said nanoparticle solution; or (iii) said surface of said support membrane is pretreated with said matrix solution and said crosslinking solution; or (iv) said matrix solution is ink-jet printed on said surface of said support membrane, optionally simultaneously with said nanoparticle solution, and said surface of said support membrane is then submersed in said crosslinker solution.

19. The method of claim 18, wherein:
a) said ink-jet printing of said nanoparticle solution is repeated n times, wherein n is an integer of 1 to 300; or
b) said ink-jet printing of said nanoparticle solution is carried out from (i) one reservoir; or (ii) more than one reservoir, wherein each one of said reservoirs contains a solution of identical or different nanoparticles; or
c) said ink-jet printing of said nanoparticle solution is carried out according to a predetermined pattern.

20. The method of claim 18, wherein said nanoparticle solution and said matrix solution are ink-jet printed together from one reservoir.

21. The method of claim 18, wherein heat treatment is applied to allow said crosslinker to completely react with said matrix and said nanoparticles.

22. The method of claim 18, wherein:
(i) said support membrane is composed of polysulfone (PSf), polyethersulfone (PES), polyacrylonitrile (PAN), polyester, polyphenyleneoxide, polyphenylenesulfide, polyvinyl chloride, polyvinylidine fluoride, polytetrafluoroethylene, polycarbonate, polyetherketone, polyetheretherketone, or a thin film composite (TFC) membrane including reverse osmosis and nanofiltration membranes having a polyamide surface; or
(ii) said crosslinker is a compound capable of cross-linking with both an alcohol and a carboxylic or amine moiety; and said matrix is a hydrophilic polymer capable of cross-linking with said crosslinker; or
(iii) said nanoparticles are carbon nanotubes (CNTs), metallic nanoparticles, nanodiamonds, or graphene quantum dots, and are optionally functionalized with functional groups capable of reacting with said crosslinker and linking to said matrix.

23. The method of claim 22, wherein:
a) said metallic nanoparticles are silver, copper or titanium containing nanoparticles; or
b) said crosslinker is a dialdehyde selected from the group consisting of glyoxal, malondialdehyde, succindialdehyde, glutaraldehyde and phthalaldehyde; and said matrix is polyvinylalcohol.

24. A membrane fabricated according to the method of claim 1.

25. A TFC polyamide membrane according to claim 24, wherein said polyamide layer has a thickness in the range of 10-500 nm.

26. A method for modification of a membrane, said method comprising:
(i) activating a surface of said membrane; and
(ii) treating the activated surface of said membrane with an aqueous solution containing monomers capable of polymerizing with each other and onto the surface of said membrane, thus forming a modified TFC membrane having improved antifouling properties while maintaining or improving salt rejection.

27. The method of claim 26, wherein said activating in step (i) is carried out with plasma, atmospheric plasma, one or more chemical radical initiators, or a UV activated initiator.

28. The method of claim 27, wherein said one or more chemical radical initiators is an azo compound such as azobisisobutyronitrile, an organic peroxide such as di-tert-butyl peroxide, benzoyl peroxide, and methyl ethyl ketone peroxide, or a mixture of a peroxydisulfate and peroxydisulfite salts such as a mixture of potassium persulfate and potassium metabisulfite; or the UV activated initiator is selected from the group consisting of Igracure 149, Igracure 184, Igracure 261, Igracure 369, Igracure 500, Igracure 651, Igracure 754, Irgacure 784, Igracure 819, Igracure 907, Igracure 1000, Igracure 2959, Degacure K126, and Degacure K185.

29. The method of claim 26, wherein:
a) said treating in step (ii) is carried out by immersing the activated surface of said membrane in said aqueous solution; or by ink jet printing of said aqueous solution onto the activated surface of said membrane, optionally according to a predetermined pattern; or
b) said activating in step (i) is carried out by a UV activated initiator; and said monomers are polymerized with each other and onto the surface of said membrane upon UV irradiation of the treated surface of said membrane.

30. The method of claim 26, wherein:
(i) said membrane is a polymer membrane selected from the group consisting of thin film composite (TFC) membranes, reverse osmosis membranes, nanofiltration membranes, ultrafiltration membranes, and microfiltration membranes; or
(ii) said monomers are either charged or neutral organic molecules containing an acrylic moiety and selected from the group consisting of methacryllic acid (MA), polyethylene glycol methacrylate (PEGMA), 2-[methacryloyloxyethyl]trimethylammonium chloride, 3-sulfopropyl methacrylate potassium salt, N-(3-sulfopropyl)-N-methacryloyloxyethyl-N,N-dimethylammonium betaine, and neutral acrylic-containing monomers including fluorine; or
(iii) said monomers are present in said aqueous solution at any ratio.

31. The method of claim 30, wherein said neutral acrylic-containing monomers including fluorine is 3-pentafluoropropyl acrylate.

32. The method of claim 26, comprising:
(i) activating a surface of said membrane with atmospheric plasma; and ink jet printing of an aqueous solution containing monomers of MA and PEGMA, optionally according to a predetermined pattern;
(ii) activating a surface of said membrane with chemical radical initiators; and ink jet printing of an aqueous solution containing monomers of MA and PEGMA, optionally according to a predetermined pattern;
(iii) activating a surface of said membrane with a UV activated initiator; immersing the activated surface of said membrane in an aqueous solution containing monomers of MA and PEGMA; and UV irradiating of the treated surface of said membrane, optionally according to a predetermined pattern; or
(iv) activating a surface of said membrane with a UV activated initiator; ink jet printing of an aqueous solution containing monomers of MA and PEGMA, optionally according to a predetermined pattern; and UV irradiating of the treated surface of said membrane.

33. A modified membrane obtained according to the method of claim 26.
